(19) United States
(12) Patent Application Publication
(10) Pub. No.: US 2026/0255390 A1
(43) Pub. Date: Aug. 27, 2026

(54) METHOD PERFORMED BY MOBILE DEVICE AND ACCESS NETWORK NODE, MOBILE DEVICE AND ACCESS NETWORK NODE

(71) Applicant: NEC Corporation, Tokyo (JP)

(72) Inventors: Pravjyot DEOGUN, Milton Keynes (GB); Hisashi FUTAKI, Tokyo (JP)

(73) Assignee: NEC Corporation, Tokyo (JP)

(21) Appl. No.: 19/489,686

(22) PCT Filed: Jun. 13, 2024
(86) PCT No.: PCT/JP2024/021548

§ 371 Date: Dec. 3, 2025

(30) Foreign Application Priority Data
Jun. 21, 2023 (GB) 2309384.2

(51) Int. Cl. H04W 74/0808; H04L 5/00

(52) U.S. Cl. CPC H04W 74/0808; H04L 5/0044

(57) ABSTRACT

A communication system is disclosed in which communication between a UE and a base station occurs in uplink only, downlink only, or full duplex, slots or symbols. Frequency resources are configured for communication in full duplex slots that include frequency resources for an uplink subband and/or frequency resources for a downlink subband. The frequency resources for the uplink subband, or the downlink subband, are distributed throughout a bandwidth of an unlicensed spectrum band, or throughout a bandwidth of a one or more subbands of an unlicensed spectrum band.

### TECHNICAL FIELD

The present disclosure relates to a communication system. The disclosure has particular but not exclusive relevance to wireless communication systems and devices thereof operating according to the 3rd Generation Partnership Project (3GPP) standards or equivalents or derivatives thereof (including LTE-Advanced, Next Generation or 5G networks, future generations, and beyond). The disclosure has particular, although not necessarily exclusive relevance to, improved apparatus and methods that support full duplex communication in time division duplex (TDD) communication bands in the context of the usage of unlicensed spectrum.

### BACKGROUND ART

Earlier developments of the 3GPP standards were referred to as the Long-Term Evolution (LTE) of Evolved Packet Core (EPC) network and Evolved UMTS Terrestrial Radio Access Network (E-UTRAN), also commonly referred as ‘4G’. More recently, the term ‘5G’ and ‘new radio’ (NR) has started to be used to refer to an evolving communication technology that is expected to support a variety of applications and services. Various details of 5G networks are described in, for example, the ‘NGMN 5G White Paper’ V1.0 by the Next Generation Mobile Networks (NGMN) Alliance, which document is available from https://www.ngmn.org/5g-white-paper.html. 3GPP intends to support 5G by way of the so-called 3GPP Next Generation (NextGen) radio access network (RAN) and the 3GPP NextGen core network.

Under the 3GPP standards, a NodeB (or an eNB in LTE, and gNB in 5G) is the radio access network (RAN) node (or simply ‘access node’, ‘access network node’ or ‘base station’) via which communication devices (user equipments or ‘UEs’) connect to a core network and communicate with other communication devices or remote servers. For simplicity, the present application will use the term access network node, RAN node or base station to refer to any such access nodes.

For simplicity, the present application will use the term mobile device, user device, or UE to refer to any communication device that is able to connect to the core network via one or more base stations. Although the present application may refer to mobile devices in the description, it will be appreciated that the technology described can be implemented on any communication devices (mobile and/or generally stationary) that can connect to a communications network for sending/receiving data, regardless of whether such communication devices are controlled by human input or software instructions stored in memory.

In the current 5G architecture, the gNB structure may be split into two or more parts. In some RAN implementations there are two parts, known as the Central Unit (CU or gNB-CU)-sometimes referred to as a ‘control unit’—and the Distributed Unit (DU or gNB-DU), connected by an F1 interface. This enables the use of a ‘split’ architecture in which the typically ‘higher’ CU layers (for example, but not necessarily or exclusively, Packet Data Convergence Protocol (PDCP) and Radio Resource Control (RRC) layers) and the, ‘lower’ DU layers (for example, but not necessarily or exclusively, Radio Link Control (RLC), Media Access Control (MAC), and Physical (PHY) layers) are separated between a particular CU, and one or more DUs that are connected to and controlled by that CU via the F1 interface. Thus, for example, the higher layer CU functionality for a number of gNBs may be implemented centrally (for example, by a single processing unit, or in a cloud-based or virtualized system), whilst retaining the lower layer DU functionality locally separately for each gNB.

In more recently proposed RAN distributed architectures, in addition to the CU and DU, the concept of a Radio Unit (RU)—sometimes referred to as a ‘remote unit’—has been introduced. In this architecture the RU is responsible for handling the digital front end (DFE), digital beamforming functionality and, typically, the functionality of the lower parts of the PHY layer, whilst the DU typically handles the higher parts of the PHY layer and the RLC and MAC layers. The CU in this architecture continues to be responsible for controlling one or more DUs (each DU corresponding to a different respective gNB) and to handle higher layer signalling (typically RRC and PDCP layers).

The actual functional split between the CU and DUs (and potentially RUs where applicable) of these distributed architectures is flexible allowing the functionality to be optimised for different use cases. Effectively, the split architecture enables a 5G network to use a different distribution of protocol stacks between CU and DUs (and potentially RUs) depending on, for example, midhaul availability and network design.

The choice of how to split functions in the architecture depends on, among other things, factors related to radio network deployment scenarios, constraints and intended supported use cases. Key considerations include: the need to support a specific quality of service for each service offered and for real/non-real time applications; support of specific user density and load demand in a given geographical area; and available transport networks with different performance levels.

Historically, communication systems have employed two core duplex schemes-frequency division duplex (FDD) and time division duplex (TDD). In FDD the frequency domain resource is split between downlink (DL) and uplink (UL) whereas in TDD the time domain resource is split between DL and UL.

The appropriate duplex scheme to be used in a given scenario is broadly spectrum dependent, albeit with some overlap. Where lower frequency bands are used for communication, paired spectrum UL and DL resource allocations are generally employed and hence FDD is used. In contrast, for higher frequency bands the use of unpaired spectrum, and hence TDD, is becoming increasingly prevalent. Thus, TDD is widely used in commercial NR deployments. Given the significantly higher carrier frequencies supported by 5G, and that will be supported by future communication generations (6G and beyond) as compared to earlier communication generations, improved techniques for providing efficient use of unpaired spectrum are, and will continue to be, increasingly critical.

### CITATION LIST

### Non Patent Literature

NPL 1: ‘NGMN 5G White Paper’ Version 1.0, [online], Feb. 17, 2015, The Next Generation Mobile Networks (NGMN) Alliance, [searched on May 23, 2024], Internet (URL: https://www.ngmn.org/5g-white-paper.html)

### SUMMARY OF INVENTION

### Technical Problem

However, allocation of too limited a time duration for the UL in TDD carriers has the potential to result in reduced coverage, increased latency, and reduced capacity.

Full duplex (FD) operation, involving sharing both frequency domain and time domain resources between the UL and the DL, within the bandwidth of a conventional TDD carrier, represents one way in which improvements may be achievable over conventional TDD performance. Accordingly, enhancements to implement full duplex operation at the base station, within TDD carriers, are currently being developed-currently with no restriction on the possible frequency ranges used for such FD operation. At present half duplex operation within TDD carriers is still envisaged for the UE, although full duplex UE operation remains an option for the future. The use of FD has, however, the potential to cause serious interference issues, both at the base station and at the UE, which are difficult to address.

There are a number of possible FD implementations that can be implemented on TDD carriers including, for example, subband non-overlapping, subband overlapping, full overlapping.

Referring to FIGS. 1 to 4, in subband non-overlapping FD (′SBFD′, also referred to as cross division duplex (XDD)), non-overlapping UL and DL subbands may be configured in the TDD carrier (as seen in the general case illustrated in FIG. 1). As seen in FIGS. 1 to 4 each subband comprises a respective relatively ‘narrow’ frequency band having a bandwidth that extends only part of the full available bandwidth within the current TDD carrier that is configured for communication in the associated cell. A base station can thus perform simultaneous (full duplex) transmission and reception at the same time, in different respective non-overlapping subbands, for different UEs.

FIG. 2 shows a particular example in which only one dedicated DL subband and one dedicated UL subband are configured in the TDD carrier. FIG. 3 shows an example in which, from the first slot to the fourth slot, full duplex operation is active where an UL subband is present in the centre of the frequency band and two DL subbands are present at either side of the DL subband. In the fifth slot, the base station uses legacy TDD operation (i.e. entire frequency band is used only for UL). FIG. 4 shows an example in which, from the first slot to the fifth slot, full duplex operation is active. In the first four slots an UL subband is present in the centre of the frequency band and two DL subbands are present at either side of the DL subband. In the fifth slot a complementary UL/DL configuration is present compared to the first four slots.

In subband overlapping FD, UL and DL may be configured in a similar way to subband non-overlapping FD, but the different subbands are allowed to overlap in frequency.

In full overlapping FD, the entire available bandwidth may be used for UL or DL transmissions.

One of the key benefits of SBFD is increased UL coverage because SBFD makes it easier to take advantage of multi-slot UL repetitions due to an increased number of consecutive UL occasions in SBFD. Currently, therefore, focus is on the development of techniques for implementing subband non-overlapping FD operation and potential related enhancements for dynamic or flexible TDD. It will be appreciated, however, that other FD implementations remain an option for the future and enhancements envisaged for sub-band non-overlapping FD may have benefits in other FD schemes.

When implementing FD schemes there are a number of considerations that need to be taken into account. Among the considerations that are particularly relevant for SBFD (and other FD schemes), for example, is the need to avoid, self-Interference. In more detail, of particular concern for the implementation of SBFD within a base station/access network is self-interference from a DL subband to a UL subband (also known as inter-subband interference). Specifically, even though the DL and the UL operate using different frequency resources, DL transmissions can interfere with UL receptions due to transceiver elements having a non-linear channel response (e.g. power amplifier). Moreover, the high DL transmission power (as compared to low UL intended signal power) can saturate an analog-to-digital conversion (ADC) unit which can greatly impact the resolution capability of ADC for UL receptions. This occurs mainly because the analog filtering operation, which is performed before ADC, only filters out transmissions outside the channel band and hence the filtering output can contain both a UL intended signal and a dominant DL transmitted signal.

There are a number of self-interference mitigation techniques which can be applied including, for example:
Self-interference cancellation mechanisms (which can be digital, analog, or a combination of both);
Spatial domain mechanisms (for example, using beams with minimal radiation overlap to reduce self-interference from DL to UL);
Power domain mitigation methods (for example, reducing DL power and/or improving UL power);
Frequency domain isolation (for example, introducing/increasing a frequency gap (i.e. guard band) between DL and UL subbands);
Filtering mechanisms (for example, performing an analog filtering operation before ADC to output only the UL subband component);
How much isolation can be achieved is dependent on both the analog filtering characteristics and any guard band between UL and DL subband and hence frequency domain and filtering solutions are generally considered together; and
Antenna isolation (given that many 5G implementations use antenna panels with multiple antenna elements, different antenna elements can be used for DL and UL to provide isolation)

As TDD full duplex (e.g., SBFD) is developed and implemented there are a number of motivations for deploying of SBFD in unlicensed spectrum. There are, for example, many potential use cases for both full duplex usage and unlicensed spectrum usage including, for example, indoor hotspots, indoor office, and factory applications. Accordingly, the need for efficient simultaneous operation of both fill duplex and unlicensed spectrum is likely in the future. Full duplex also has the potential to address many prevalent issues of unlicensed operation e.g., high channel contention due to DL-UL interruption, thus increasing the performance of unlicensed operation. Moreover, for future generations of communication technology (e.g., 6G), full duplex is expected to be supported from the first release, while unlicensed operation is a likely scenario, hence it is important to consider how they may coexist with one another effectively.

There are, however, a number of considerations that have to be taken into account for operation in unlicensed spectrum. For example, there are a number of regulatory requirements for unlicensed operation including, for example, regulatory constraints on: the maximum Equivalent Isotropic Radiation Power (EIRP) which restricts the power transmitted during each symbol; the occupied channel bandwidth (e.g., requiring that the bandwidth containing 99% of the power of the signal is between 80% and 100% of the unlicensed channel bandwidth reserved for communication); and the required channel access procedure (e.g., listen before talk operation) before initiating communication.

However, even though there is no restriction on frequency range deployment for full duplex, at present, full duplex operation is currently not suitable for unlicensed channel operation. In particular, issues may arise from the transmission, only within a UL or DL subband bandwidth (that is characteristic of SBFD transmission) due to the regulatory occupied channel bandwidth requirement. For example, when a base station transmits on a DL subband then a large portion of the channel bandwidth may remain unutilized which can reduce the occupied channel bandwidth below the 80% typically required by regulatory requirements. Moreover, the current channel access procedure does not take into account of the possibility that UL and DL communication may occur in the same symbol.

One such channel access mechanism is ‘listen-before-talk’ (LBT) in which transmitting devices (UE/base station) are typically expected to perform some form of clear channel assessment (CCA) involving “sensing” the medium to detect any transmissions from other nodes. When an LBT procedure is successful, the channel is deemed to be clear and is, in effect, reserved for a duration of time known as a Channel Occupancy Time (COT) within which to transmit. The CCA may, for example, involve energy detection (i.e., measuring the received energy level of any signals transmitted from other devices) and determining whether a channel is idle or busy based on the detected energy. There are different scenarios in which different LBT requirements are appropriate including some in which channel access can be performed immediately (without requiring a sensing/listening step). The LBT procedure is performed over a bandwidth of 20 MHz and can be of different types allowing different COT durations.

Four LBT categories are currently defined for (dynamic) channel access for NR communication in unlicensed bands:
Cat 4 LBT with a contention window (also known as ‘Type 1’)
Cat 2 LBT in which a UE can sense the channel within a 25 μs gap (also known as ‘Type 2A’)
Cat 2 LBT in which a UE can sense the channel within a 16 μs gap (T also known as ‘Type 2B’)
Cat 1 LBT in which there is a 16 μs gap but channel sensing/LBT is not required (also known as ‘Type 2C’). This type of LBT is only allowed for very limited scenarios

In more detail, for Type-1 LBT, a UE senses the channel for a variable contention window period. A respective channel access priority class (CAPC) can be configured for each data radio bearer (DRB), where a higher CAPC corresponds to a lower priority. Signalling radio bearers (SRBs)—which carry control signals such as RRC and non-access stratum (NAS) messages-always (with the exception of SRB2) use the CAPC corresponding to the highest priority. A number of different priority levels/CAPCs have been defined for Type-1 LBT which differ in COT duration and sensing duration (i.e., contention window period). An exemplary set of these CAPCs are illustrated in Table 1.

TABLE 1
Channel Access Priority Classes

| Channel | | | | |
|---|---|---|---|---|
| Access Priority | | | | |
| Class (p) | mₚ | CW_{min, p} | CW_{max, p} | T_{ulm, cot, p} |
| 1 | 2 | 3 | 7 | 2 ms |
| 2 | 2 | 7 | 15 | 4 ms |
| 3 | 3 | 15 | 1023 | 6 ms or 10 ms |
| 4 | 3 | 15 | 1023 | 6 ms or 10 ms |

As seen in Table 1, the contention window (CWp) for a given priority class (p) has a duration between a minimum contention window for that priority class (CWmin,p) and a maximum contention window for that priority class (CWmax,p). The maximum uplink COT duration is given by Tulm, cot,p. The number of sensing slots is given by the parameter mp. It will be appreciated that a different set of CAPCs may be defined with different numbers of sensing slots, COT duration and contention window duration.

As currently proposed, SBFD will not be able to guarantee the occupancy bandwidth requirement required by regulation for unlicensed channels. Specifically, as each base station's transmissions and each UE's transmissions are only restricted to their respective DL/UL subbands, this can lead to significant bandwidth remaining unoccupied when using an unlicensed channel. For example, when a base station has acquired a COT for DL communication one or more UL subbands may remain unused and when a UE has acquired a COT for UL communication one or more DL subbands may remain unused. Accordingly, where regulatory requirements expect at least a minimum (typically 80%) bandwidth occupancy, SBFD may not be able to meet this requirement.

The disclosure aims to provide one or more apparatus, and one or more associated methods, that at least partially contribute to addressing the above issues.

### Solution to Problem

In one aspect the disclosure provides a method performed by a user equipment (UE), the method comprising: communicating, with an access network node, in at least one time resource of a plurality of time resources, wherein each resource of the plurality of time resources are respectively configurable for downlink communication only, for uplink communication only, or for both uplink communication and downlink communication; wherein the communicating includes receiving, from the access network node, configuration information for configuring frequency resources for communication with the access network node in at least one time resource that is configured for both uplink communication and downlink communication, the frequency resources comprising at least one of an uplink set of frequency resources for uplink communication, or a downlink set of frequency resources for downlink communication, and the configuration information configures the at least one of the uplink set of frequency resources for uplink communication, or the downlink set of frequency resources for downlink communication, to be distributed throughout at least one unlicensed bandwidth.

The configuration information may configure the at least one of the uplink set of frequency resources for uplink communication, or the downlink set of frequency resources for downlink communication, to comprise at least one interlaced set of frequency resources. The at least one interlaced set of frequency resources may be based on a first interlace format, the method may further comprises receiving further configuration information for configuring further frequency resources for communication with the access network node in at least one time resource that is configured for uplink communication only and/or at least one time resource that is configured for downlink communication only, and the further configuration information may configure the further frequency resources to comprise at least one further interlaced set of frequency resources based on a second interlace format that is different to the first interlace format.

The method may further comprise determining an unused set of frequency resources to remain unused for uplink or downlink communication in the at least one unlicensed bandwidth. The unused set of frequency resources may be determined from further configuration information, received from the access network node, for explicitly configuring the unused set of frequency resources.

The unused set of frequency resources may be determined based on the at least one of the uplink set of frequency resources for uplink communication, or the downlink set of frequency resources for downlink communication.

The method may further comprise receiving downlink transmissions that are rate matched around frequency resources that do not belong to the downlink set of frequency resources.

The configuration information may configure the uplink set of frequency resources for uplink communication, and the method may further comprise receiving downlink transmissions that are rate matched around at least the uplink set of frequency resources.

The method may further comprise receiving an indication of at least one downlink interlace within the downlink set of frequency resources, and receiving downlink transmissions using the at least one downlink interlace. The method may further comprise receiving an indication of at least one uplink interlace within the uplink set of frequency resources, and transmitting uplink transmissions using the at least one uplink interlace.

The method may further comprise receiving an indication that the access network node has acquired a channel occupancy time for downlink transmissions, and performing a channel access procedure to gain access to the at least one unlicensed bandwidth for uplink transmissions during the channel occupancy time. The channel access procedure may be a type of channel access procedure that does not require a listen before talk (LBT) to be performed to gain access to the at least one unlicensed bandwidth.

Channel access using the channel access procedure that does not require LBT may be restricted to at least one of the following: a maximum number of uplink transmissions within the channel occupancy time; UEs associated with a beam that is used by the access network node to perform LBT to gain access to the at least one unlicensed bandwidth, and/or to perform downlink transmission; and/or a case where the access network node has gained access to the at least one unlicensed bandwidth using a contention based LBT for transmission having a priority associated with a longest contention window period.

The channel access procedure may be a type of channel access procedure that requires a listen before talk (LBT) to be performed to gain access to the at least one unlicensed bandwidth.

The method may further comprise performing the LBT in a period during which downlink communication by the access network node is suspended. The period during which downlink communication by the access network node is suspended may be configured to occur in at least one predefined time resource. The at least one predefined time resource may include a symbol at the start of a slot and/or a 7th symbol of a slot or subframe. The period during which downlink communication by the access network node is suspended may be configured to occur between two different downlink transmissions. The period during which downlink communication by the access network node is suspended may be configured to occur during an ongoing downlink transmission. The method may further comprise receiving an indication of the timing and/or duration of the period during which downlink communication by the access network node is suspended. The period during which downlink communication by the access network node is suspended may be configured to be no greater than a maximum gap required for a Type-2 LBT procedure.

The at least one unlicensed bandwidth may comprise a plurality of unlicensed bandwidths forming a total unlicensed bandwidth, each unlicensed bandwidth may respectively correspond to a different set of contiguous frequency resources, and the configuration information may respectively configure each set of frequency resources either as at least part of the uplink set of frequency resources, or as at least part of the downlink set of frequency resources.

The method may further comprise receiving an indication of at least one uplink interlace within the uplink set of frequency resources, and transmitting uplink transmissions using resources corresponding to an intersection between the at least one uplink interlace and the uplink set of frequency resources.

The configuration information may configure a first plurality of the sets of contiguous frequency resources as the uplink set of frequency resources, and/or a second plurality of the sets of contiguous frequency resources as the downlink set of frequency resources. The configuration information may configure each set of contiguous frequency resources either as a different respective uplink set of frequency resources, or as a different respective set of downlink set of frequency resources.

The method may further comprise receiving an indication that the access network node has acquired a channel occupancy time for downlink transmissions, following a listen before talk (LBT) performed in respect of the at least one set of contiguous frequency resources configured as at least part of the downlink set of frequency resources and in respect of the at least one set of contiguous frequency resources configured as at least part of the uplink set of frequency resources, and performing a channel access procedure to gain access to the at least one unlicensed bandwidth for uplink transmissions during the channel occupancy time.

The channel access procedure may be a type of channel access procedure that does not require an LBT to be performed to gain access to the at least one unlicensed bandwidth.

The indication that the access network node has acquired a channel occupancy time for downlink transmissions may be received without a prior downlink transmission being performed, by the access network node, in the uplink set of frequency resources. The indication that the access network node has acquired a channel occupancy time for downlink transmissions may be received after a prior downlink transmission is performed, by the access network node, in the uplink set of frequency resources. The prior downlink transmission may be performed, by the access network node, at the start of the at least one time resource that is configured for both uplink communication and downlink communication. The prior downlink transmission may performed, by the access network node, before the at least one time resource that is configured for both uplink communication and downlink communication.

The method may further comprise receiving an indication that the access network node has acquired a channel occupancy time for downlink transmissions, following a listen before talk (LBT) performed in respect of the at least one set of contiguous frequency resources configured as at least part of the downlink set of frequency resources but not in respect of the at least one set of contiguous frequency resources configured as at least part of the uplink set of frequency resources, and performing a channel access procedure to gain access to the at least one unlicensed bandwidth for uplink transmissions during the channel occupancy time.

The channel access procedure may be a type of channel access procedure that requires a contention based LBT to be performed to gain access to the at least one unlicensed bandwidth.

The indication that the access network node has acquired a channel occupancy time may indicate at least one of the following: a duration of the channel occupancy time; which one or more sets of contiguous frequency resources the channel occupancy time is applicable for; or one or more frequency regions for which the channel occupancy time is applicable.

In one aspect the disclosure provides a method performed by a user equipment (UE), the method comprising: communicating, with an access network node, in at least one time resource of a plurality of time resources, wherein each resource of the plurality of time resources are respectively configurable for downlink communication only, for uplink communication only, or for both uplink communication and downlink communication; wherein the communicating includes performing at least one transmission, to the access network node, using frequency resources of an unlicensed bandwidth in at least one time resource configured for both uplink communication and downlink communication, and the transmission is performed subject to at least one of the following conditions being met: a condition that a first set of frequency resources, for one of uplink and downlink communication, extend no more than a first predefined proportion of the unlicensed bandwidth, and/or a second set of frequency resources, for the other of uplink and downlink communication, extends no less than a second predefined proportion of the unlicensed bandwidth; a condition that no other communicating node is detected as being present in a vicinity of the access network node and/or the UE; a condition that a distance between the UE and access network node is less than a distance threshold; a condition that a beam used by the access network node and/or UE has a beam width in at least one dimension that is greater than a threshold value, or is an omnidirectional beam; or a condition that a semi-static channel occupancy mode, or frame-based equipment (FBE) mode, is used at the UE for channel access.

In one aspect the disclosure provides a method performed by a user equipment (UE), the method comprising: communicating, with an access network node, using an unlicensed bandwidth in at least one time resource; wherein, in a case where the at least one time resource is configured for uplink communication only or for downlink communication only, the communicating is performed based on a first configuration for accessing the unlicensed bandwidth, and in a case where the at least one time resource is configured for both uplink communication and downlink communication, the communicating is performed based on a second configuration for accessing the unlicensed bandwidth, that is different to the first configuration.

The communicating may include performing a channel access procedure to gain access to the unlicensed bandwidth in the at least one time resource, and, in a case where the at least one time resource is configured for uplink communication only, the channel access procedure may be performed based on the first configuration, and in a case where the at least one time resource is configured for both uplink communication and downlink communication, the channel access procedure may be performed based on the second configuration.

The method may further comprise receiving, from the access network node before performing the channel access procedure, first information corresponding to the first configuration, and second information corresponding to the second configuration.

The first configuration may define a first channel access configuration for accessing at least one time resource configured for uplink communication only, and the second configuration may define a second channel access configuration for accessing at least one time resource configured for both uplink communication and downlink communication.

The first configuration may define a first set of uplink resources for uplink communication in at least one time resource configured for uplink communication only and/or a first set of downlink resources for downlink communication in at least one time resource configured for downlink communication only, and the second configuration may define a second set of uplink resources for uplink communication and/or a second set of downlink resources for downlink communication in at least one time resource configured for both uplink communication and downlink communication.

The first configuration may define a first contention window configuration for channel access in at least one time resource configured for uplink communication only, and the second configuration may define a second contention window configuration for channel access in at least one time resource configured for both uplink communication and downlink communication.

In one aspect the disclosure provides a method performed by an access network node, the method comprising: communicating, with a user equipment (UE), in at least one time resource of a plurality of time resources, wherein each resource of the plurality of time resources are respectively configurable for downlink communication only, for uplink communication only, or for both uplink communication and downlink communication; wherein the communicating includes transmitting, to the UE, configuration information for configuring frequency resources for communication with the UE in at least one time resource that is configured for both uplink communication and downlink communication, the frequency resources comprising at least one of an uplink set of frequency resources for uplink communication, or a downlink set of frequency resources for downlink communication, and the configuration information configures the at least one of the uplink set of frequency resources for uplink communication, or the downlink set of frequency resources for downlink communication, to be distributed throughout at least one unlicensed bandwidth.

In one aspect the disclosure provides a method performed by an access network node, the method comprising: communicating, with a user equipment (UE), in at least one time resource of a plurality of time resources, wherein each resource of the plurality of time resources are respectively configurable for downlink communication only, for uplink communication only, or for both uplink communication and downlink communication; wherein the communicating includes receiving a transmission from the UE, using frequency resources of an unlicensed bandwidth in at least one time resource configured for both uplink communication and downlink communication, and the transmission is performed by the UE subject to at least one of the following conditions being met: a condition that a first set of frequency resources, for one of uplink and downlink communication, extend no more than a first predefined proportion of the unlicensed bandwidth, and/or a second set of frequency resources, for the other of uplink and downlink communication, extends no less than a second predefined proportion of the unlicensed bandwidth; a condition that no other communicating node is detected as being present in a vicinity of the access network node and/or the UE; a condition that a distance between the UE and access network node is less than a distance threshold; a condition that a beam used by the access network node and/or UE has a beam width in at least one dimension that is greater than a threshold value, or is an omnidirectional beam; or a condition that a semi-static channel occupancy mode, or frame-based equipment (FBE) mode, is used at the UE for channel access.

In one aspect the disclosure provides a method performed by an access network node, the method comprising: communicating, with a user equipment (UE), using an unlicensed bandwidth in at least one time resource; wherein, in a case where the at least one time resource is configured for uplink communication only or for downlink communication only, the communicating is performed based on a first configuration for accessing the unlicensed bandwidth, and in a case where the at least one time resource is configured for both uplink communication and downlink communication, the communicating is performed based on a second configuration for accessing the unlicensed bandwidth, that is different to the first configuration.

In one aspect the disclosure provides a user equipment (UE) comprising: means for communicating, with an access network node, in at least one time resource of a plurality of time resources, wherein each resource of the plurality of time resources are respectively configurable for downlink communication only, for uplink communication only, or for both uplink communication and downlink communication; wherein the communicating includes receiving, from the access network node, configuration information for configuring frequency resources for communication with the access network node in at least one time resource that is configured for both uplink communication and downlink communication, the frequency resources comprising at least one of an uplink set of frequency resources for uplink communication, or a downlink set of frequency resources for downlink communication, and the configuration information configures the at least one of the uplink set of frequency resources for uplink communication, or the downlink set of frequency resources for downlink communication, to be distributed throughout at least one unlicensed bandwidth.

In one aspect the disclosure provides a user equipment (UE) comprising: means for communicating, with an access network node, in at least one time resource of a plurality of time resources, wherein each resource of the plurality of time resources are respectively configurable for downlink communication only, for uplink communication only, or for both uplink communication and downlink communication; wherein the communicating includes performing at least one transmission, to the access network node, using frequency resources of an unlicensed bandwidth in at least one time resource configured for both uplink communication and downlink communication, and the transmission is performed subject to at least one of the following conditions being met: a condition that a first set of frequency resources, for one of uplink and downlink communication, extend no more than a first predefined proportion of the unlicensed bandwidth, and/or a second set of frequency resources, for the other of uplink and downlink communication, extends no less than a second predefined proportion of the unlicensed bandwidth; a condition that no other communicating node is detected as being present in a vicinity of the access network node and/or the UE; a condition that a distance between the UE and access network node is less than a distance threshold; a condition that a beam used by the access network node and/or UE has a beam width in at least one dimension that is greater than a threshold value, or is an omnidirectional beam; or a condition that a semi-static channel occupancy mode, or frame-based equipment (FBE) mode, is used at the UE for channel access.

In one aspect the disclosure provides a user equipment (UE) comprising: means for communicating, with an access network node, using an unlicensed bandwidth in at least one time resource; wherein, in a case where the at least one time resource is configured for uplink communication only or for downlink communication only, the communicating is performed based on a first configuration for accessing the unlicensed bandwidth, and in a case where the at least one time resource is configured for both uplink communication and downlink communication, the communicating is performed based on a second configuration for accessing the unlicensed bandwidth, that is different to the first configuration.

In one aspect the disclosure provides an access network node comprising: means for communicating, with a user equipment (UE), in at least one time resource of a plurality of time resources, wherein each resource of the plurality of time resources are respectively configurable for downlink communication only, for uplink communication only, or for both uplink communication and downlink communication; wherein the communicating includes transmitting, to the UE, configuration information for configuring frequency resources for communication with the UE in at least one time resource that is configured for both uplink communication and downlink communication, the frequency resources comprising at least one of an uplink set of frequency resources for uplink communication, or a downlink set of frequency resources for downlink communication, and the configuration information configures the at least one of the uplink set of frequency resources for uplink communication, or the downlink set of frequency resources for downlink communication, to be distributed throughout at least one unlicensed bandwidth.

In one aspect the disclosure provides an access network node comprising: means for communicating, with a user equipment (UE), in at least one time resource of a plurality of time resources, wherein each resource of the plurality of time resources are respectively configurable for downlink communication only, for uplink communication only, or for both uplink communication and downlink communication; wherein the communicating includes receiving a transmission from the UE, using frequency resources of an unlicensed bandwidth in at least one time resource configured for both uplink communication and downlink communication, and the transmission is performed by the UE subject to at least one of the following conditions being met: a condition that a first set of frequency resources, for one of uplink and downlink communication, extend no more than a first predefined proportion of the unlicensed bandwidth, and/or a second set of frequency resources, for the other of uplink and downlink communication, extends no less than a second predefined proportion of the unlicensed bandwidth; a condition that no other communicating node is detected as being present in a vicinity of the access network node and/or the UE; a condition that a distance between the UE and access network node is less than a distance threshold; a condition that a beam used by the access network node and/or UE has a beam width in at least one dimension that is greater than a threshold value, or is an omnidirectional beam; or a condition that a semi-static channel occupancy mode, or frame-based equipment (FBE) mode, is used at the UE for channel access.

In one aspect the disclosure provides an access network node comprising: means for communicating, with a user equipment (UE), using an unlicensed bandwidth in at least one time resource; wherein, in a case where the at least one time resource is configured for uplink communication only or for downlink communication only, the communicating is performed based on a first configuration for accessing the unlicensed bandwidth, and in a case where the at least one time resource is configured for both uplink communication and downlink communication, the communicating is performed based on a second configuration for accessing the unlicensed bandwidth, that is different to the first configuration.

It will be appreciated that while the communication system to which the present application relates is described in the context of full duplex enhancement at the base station side, half duplex operation at the UE side, and no restriction on the frequency ranges; the enhancements described may have benefit in other communication systems. For example, communication systems in which the UE is capable of full duplex operation and/or there are restrictions on the frequency ranges that may be used.

### BRIEF DESCRIPTION OF DRAWINGS

Example embodiments of the disclosure will now be described, by way of example, with reference to the accompanying drawings.

FIG. 1 is simplified time frequency diagram illustrating a subband non-overlapping full duplex scheme and various exemplary implementations of such a scheme.

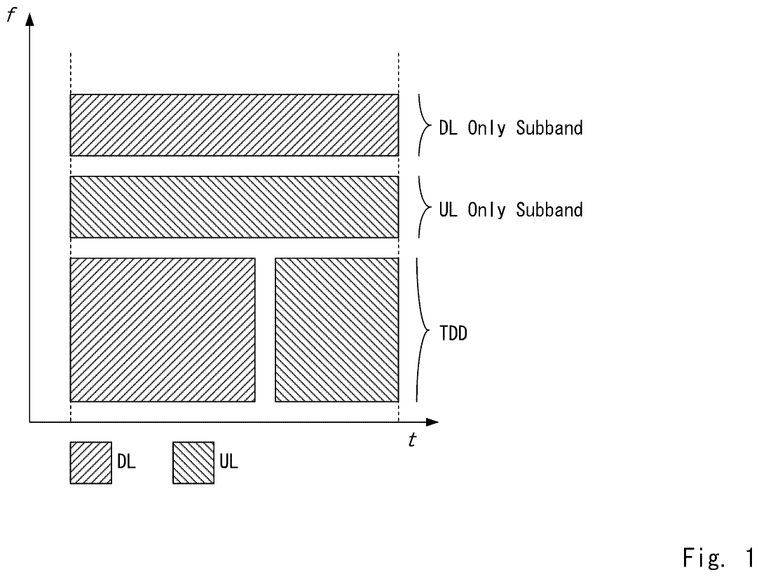

FIG. 2 is simplified time frequency diagram illustrating a subband non-overlapping full duplex scheme and various exemplary implementations of such a scheme.

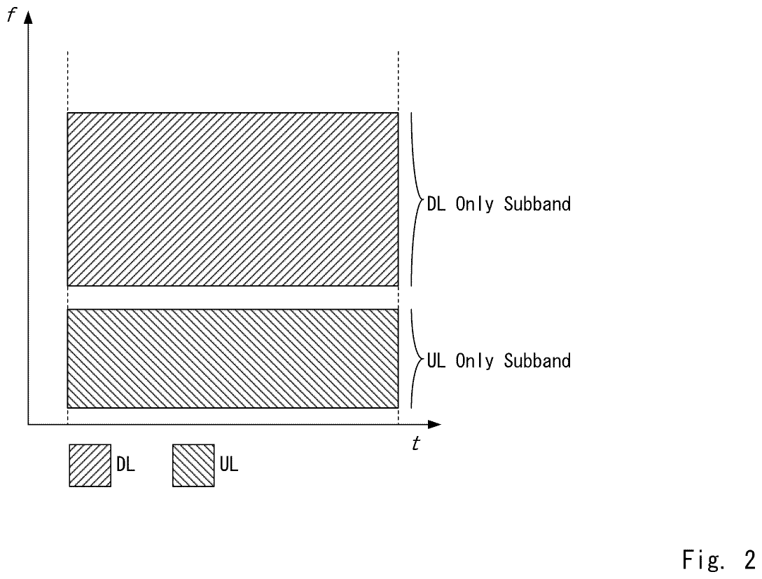

FIG. 3 is simplified time frequency diagram illustrating a subband non-overlapping full duplex scheme and various exemplary implementations of such a scheme.

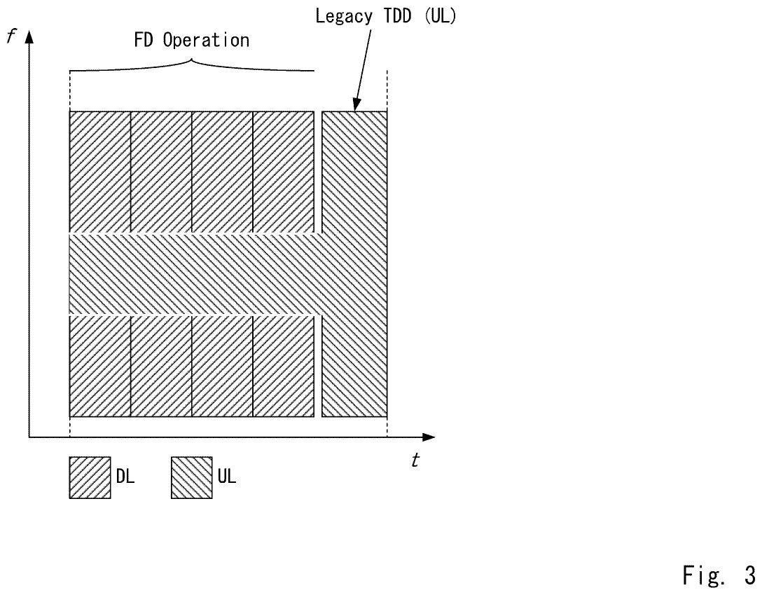

FIG. 4 is simplified time frequency diagram illustrating a subband non-overlapping full duplex scheme and various exemplary implementations of such a scheme.

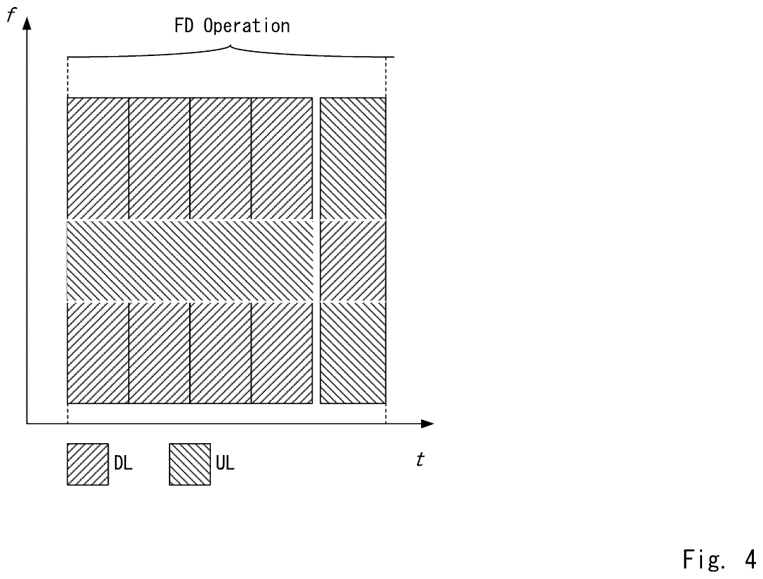

FIG. 5 schematically illustrates a mobile (‘cellular’ or ‘wireless’) communication system.

FIG. 6 illustrates a typical frame structure that may be used in the communication system of FIG. 5.

FIG. 7 is a simplified sequence diagram illustrating different slot configuration procedures that can be employed in the communication system of FIG. 5.

FIG. 8 shows illustrative examples of slot configurations configured by the procedures of FIG. 7.

FIG. 9 is a simplified time frequency diagram showing an illustrative example of a full duplex configuration that may be used in the communication system of FIG. 5.

FIG. 10 is a simplified time frequency diagram showing an illustrative example of another full duplex configuration that may be used in the communication system of FIG. 5.

FIG. 11 is a simplified time frequency diagram showing an illustrative example of another full duplex configuration that may be used in the communication system of FIG. 5.

FIG. 12A illustrates an example in which a channel occupancy time is shared between a base station and UE for accessing unlicensed spectrum in the communication system of FIG. 5.

FIG. 12B illustrates another example in which a channel occupancy time is shared between a base station and UE for accessing unlicensed spectrum in the communication system of FIG. 5.

FIG. 12C illustrates other example in which a channel occupancy time is shared between a base station and UE for accessing unlicensed spectrum in the communication system of FIG. 5.

FIG. 13 is a simplified example of an interlaced resource allocation in an unlicensed band that may be used in the communication system of FIG. 5.

FIG. 14 a simplified time frequency diagram illustrating an example of an interlaced allocation of resources for downlink and uplink subbands that may be supported in the communication system of FIG. 5.

FIG. 15 is a simplified time frequency diagram illustrating an example of how LBT may be implemented for UL communication in the communication system of FIG. 5.

FIG. 16 is a simplified time frequency diagram illustrating another example of how LBT may be implemented for UL communication in the communication system of FIG. 5.

FIG. 17 is a simplified time frequency diagram illustrating another example of how SBFD may be implemented for unlicensed spectrum in the communication system of FIG. 5.

FIG. 18 is a simplified time frequency diagram illustrating one LBT technique that may be used, in the context of SBFD based on LBT subbands, in the communication system of FIG. 5.

FIG. 19 is a simplified time frequency diagram illustrating another LBT technique that may be used, in the context of SBFD based on LBT subbands, in the communication system of FIG. 5.

FIG. 20 is a simplified time frequency diagram illustrating another example of how SBFD may be implemented in the communication system of FIG. 5.

FIG. 21 is a simplified sequence diagram illustrating a number of different ways in which channel access parameters may be configured in the communication system of FIG. 5.

FIG. 22 is a schematic block diagram illustrating the main components of a UE for the communication system of FIG. 5.

FIG. 23 is a schematic block diagram illustrating the main components of a base station for the communication system of FIG. 5.

### DESCRIPTION OF EMBODIMENTS

### Overview

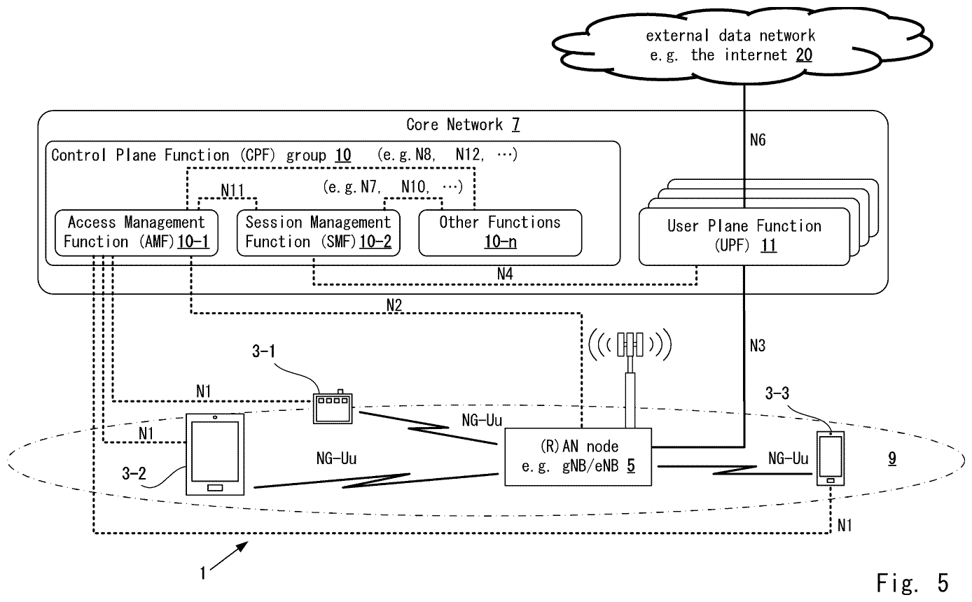

An exemplary communication system will now be described in general terms, by way of example only, with reference to FIGS. 5 to 13.

FIG. 5 schematically illustrates a mobile (‘cellular’ or ‘wireless’) communication system 1 to which example embodiments of the present disclosure are applicable.

In the communication system 1, user equipment (UEs) 3-1, 3-2, 3-3 (e.g. mobile telephones and/or other mobile devices) can communicate with each other via a radio access network (RAN) node 5 that operates according to one or more compatible radio access technologies (RATs). In the illustrated example, the RAN node 5 comprises a base station 5 or ‘gNB’ 5 operating one or more associated cells 9. Communication via the base station 5 is typically routed through a core network 7 (e.g. a 5G/6G or later generations core network or evolved packet core network (EPC)).

As those skilled in the art will appreciate, whilst three UEs 3 and one base station 5 are shown in FIG. 5 for illustration purposes, the system, when implemented, will typically include other RAN nodes and UEs.

Each base station 5 controls one or more associated cells 9 either directly, or indirectly via one or more other nodes (such as home base stations, relays, remote radio heads, distributed units, and/or the like). It will be appreciated that the base stations 5 may be configured to support 4G, 5G, 6G, and/or later generations, and/or any other 3GPP or non-3GPP communication protocols.

The UEs 3 and their serving base station 5 are connected via an appropriate air interface (for example the so-called ‘Uu’ interface and/or the like). Neighbouring base stations 5 may be connected to each other via an appropriate base station to base station interface (such as the so-called ‘X2’ interface, ‘Xn’ interface and/or the like).

The core network 7 includes a number of logical nodes (or ‘functions’) for supporting communication in the communication system 1. In this example, the core network 7 comprises control plane functions (CPFs) 10 and one or more network node entities for the communication of user data (e.g. user plane functions (UPFs)) 11. The CPFs 10 include one or more network node entities for the communication of control signalling (e.g. Access and Mobility Management Functions (AMFs)) 10-1, one or more network node entities for session management (e.g. Session Management Functions (SMFs)) 10-2 and a number of other functions 10-n (such as, for example an Authentication Server Function (AUSF) which facilitates 5G security processes).

The base station 5 is connected to the core network nodes via appropriate interfaces (or ‘reference points’) such as an N2 reference point between the base station 5 and the AMF 10-1 for the communication of control signalling, and an N3 reference point between the base station 5 and each UPF 11 for the communication of user data. The UEs 3 are each connected to the AMF 10-1 via a NAS connection over an appropriate reference point (e.g. an N1 reference point (analogous to the S1 reference point in LTE)). It will be appreciated, that N1 communications are routed transparently via the base station 5.

One or more UPFs 11 are connected to an external data network 20 (e.g. an IP network such as the internet) via an appropriate reference point (e.g. N6 reference point) for communication of the user data.

The AMF 10-1 performs mobility management related functions, maintains the NAS connection with each UE 3 and manages UE registration. The AMF 10-1 receives user information sent through the network and forwards the information to the SMF 10-2. The AMF 10-1 is also responsible for managing paging.

The SMF 10-2 provides session management functionality (that formed part of MME functionality in LTE) and additionally combines some control plane functions (provided by the serving gateway and packet data network gateway in LTE). The SMF 10-2 uses user information provided via the AMF 10-1 to determine what session manager would be best assigned to the user. The SMF 10-2 may be considered effectively to be a gateway from the user plane to the control plane of the network. The SMF 10-2 also allocates IP addresses to each UE 3.

The base station 5 of the communication system 1 is configured to operate at least one cell 9 on an associated TDD carrier that operates in unpaired spectrum. It will be appreciated that the base station 5 may also operate at least one cell 9 on an associated FDD carrier that operates in paired spectrum.

The base station 5 is also configured for transmission of, and the UEs 3 are configured for the reception of, control information and user data via a number of downlink (DL) physical channels and for transmission of a number of physical signals. The DL physical channels correspond to resource elements (REs) carrying information originated from a higher layer, and the DL physical signals are used in the physical layer and correspond to REs which do not carry information originated from a higher layer.

The physical channels may include, for example, a physical downlink shared channel (PDSCH), a physical broadcast channel (PBCH), and a physical downlink control channel (PDCCH). The PDSCH carries data sharing the PDSCH's capacity on a time and frequency basis. The PDSCH can carry a variety of items of data including, for example, user data, UE-specific higher layer control messages mapped down from higher channels, system information blocks (SIBs), and paging. The PDCCH carries downlink control information (DCI) for supporting a number of functions including, for example, scheduling the downlink transmissions on the PDSCH and also the uplink data transmissions on a physical uplink shared channel (PUSCH). The PBCH provides UEs 3 with the Master Information Block (MIB). It also, in conjunction with the PDCCH, supports the synchronization of time and frequency, which aids cell acquisition, selection and re-selection.

The DL physical signals may include, for example, reference signals (RSs) and synchronization signals (SSs). A reference signal (sometimes known as a pilot signal) is a signal with a predefined special waveform known to both the UE 3 and the base station 5. The reference signals may include, for example, cell specific reference signals, UE-specific reference signal (UE-RS), downlink demodulation reference signals (DMRS), and channel state information reference signal (CSI-RS).

Similarly, the UEs 3 are configured for transmission of, and the base station 5 is configured for the reception of, control information and user data via a number of uplink (UL) physical channels corresponding to REs carrying information originated from a higher layer, and UL physical signals which are used in the physical layer and correspond to REs which do not carry information originated from a higher layer. The physical channels may include, for example, the PUSCH, a physical uplink control channel (PUCCH), and/or a physical random-access channel (PRACH). The UL physical signals may include, for example, uplink demodulation reference signals (DMRS) for a UL control/data signal, and/or sounding reference signals (SRS) used for UL channel measurement.

The base station 5 is also configured to transmit synchronization signal blocks (SSBs) periodically in one or more cells 9 that it operates. The SSB includes both synchronization signals (e.g., a primary synchronization signal (PSS) and a secondary synchronization signal (SSS)) and the PBCH carrying a MIB that provides at least part of the minimum system information for accessing the corresponding cell 9 (e.g., parameters required for acquiring system information block 1 (SIB1) which carries other minimum system information).

Each UE 3 is configured to search for SSBs when scanning for a cell to camp on and to decode the associated PBCH before proceeding to decode other system information transmitted on the PDSCH. Each UE 3 is also configured to perform measurements on specific resources configured for the SSBs, for example reference signal received power (RSRP), reference signal received quality (RSRQ), and/or signal to interference and noise ratio (SINR) measurements or the like.

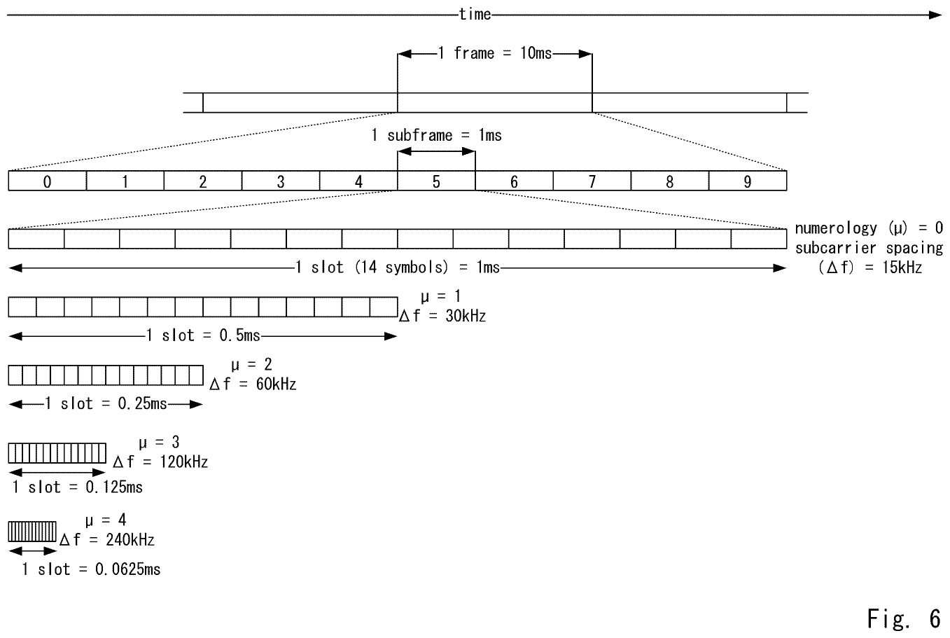

Frame Structure Referring to FIG. 6, which illustrates the typical frame structure that may be used in the communication system 1, the base station 5 and UEs 3 of the communication system 1 communicate with one another using resources that are organized, in the time domain, into frames of length 10 ms. Each frame comprises ten equally sized subframes of 1 ms length. Each subframe is divided into one or more slots comprising 14 Orthogonal frequency-division multiplexing (OFDM) symbols of equal length.

As seen in FIG. 6, the communication system 1 supports multiple different numerologies (subcarrier spacing (SCS), slot lengths and hence OFDM symbol lengths). Specifically, each numerology is identified by a parameter, μ, where μ=0 represents 15 kHz (corresponding to the LTE SCS). Currently, the SCS for other values of u can, in effect, be derived from μ=0 by scaling up in powers of 2 (i.e. SCS=15×2^{μ} kHz). The relationship between the parameter, μ, and SCS (Δf) is as shown in Table 2.

TABLE 2
5G Numerology

| | | Number of slots | Slot length |
|---|---|---|---|
| μ | Δf = 2^{μ} · 15[kHz] | per subframe | (ms) |
| 0 | 15 | 1 | 1 |
| 1 | 30 | 2 | 0.5 |
| 2 | 60 | 4 | 0.25 |
| 3 | 120 | 8 | 0.125 |
| 4 | 240 | 16 | 0.0625 |

### General Slot Configuration

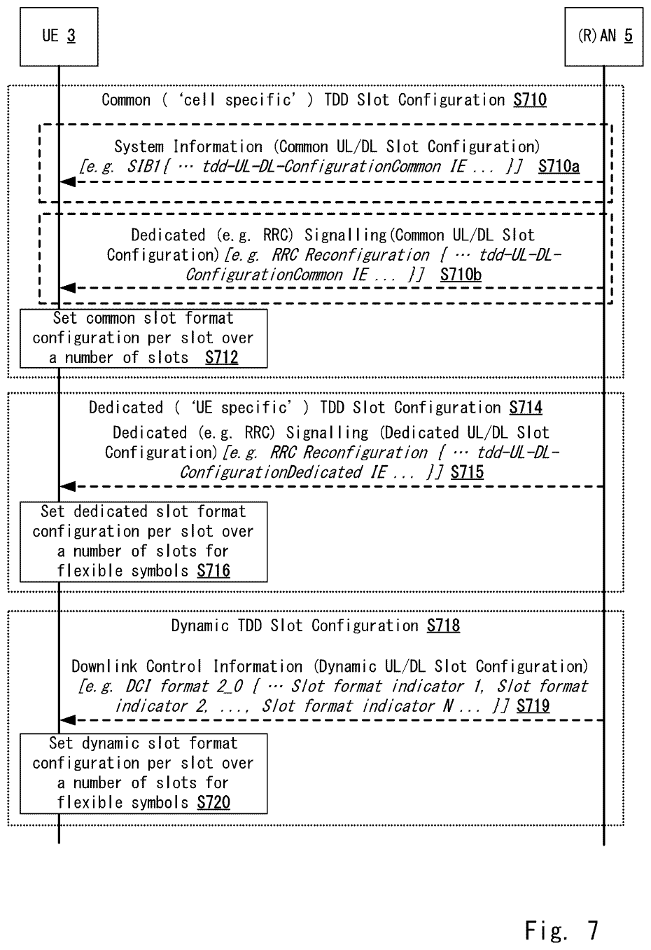

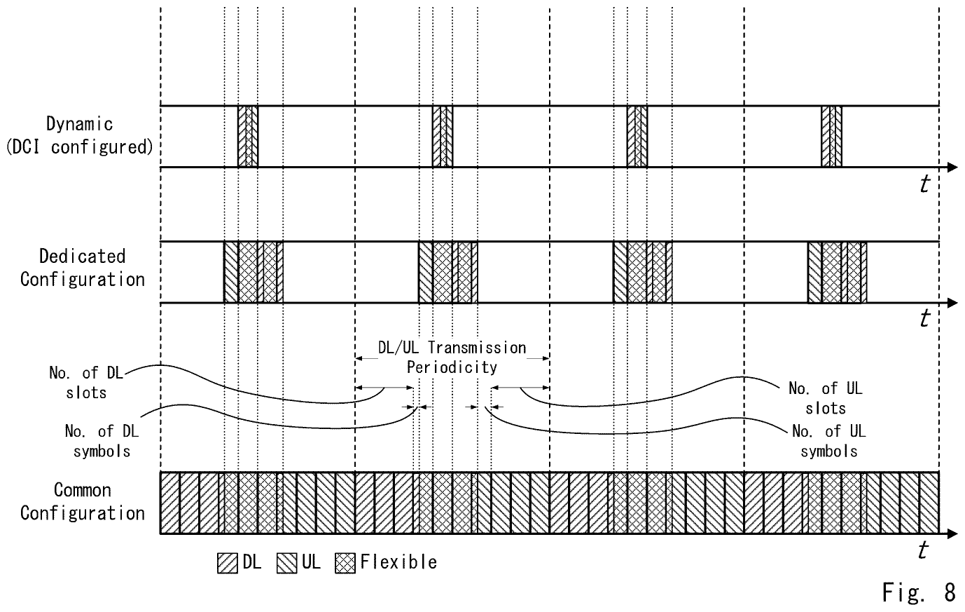

Referring to FIGS. 7 and 8 the base station 5 configures the slot usage within each cell 9 operated on a TDD carrier appropriately.

As seen in FIG. 7, which is a simplified sequence diagram illustrating different slot configuration procedures (S710, S714, S718) that can be employed in the communication system 1, the base station 5 is capable of employing a number of different procedures for configuring slot usage in each cell 9 operated on the TDD carrier.

As seen in procedure S710, for example, the base station 5 of the communication system 1 is configured for providing a respective common (or ‘cell specific’) slot configuration, for each cell 9 operated on a TDD carrier. This common slot configuration can be provided using system information (as illustrated at S710a) to all UEs 3 within the cell (for example in a tdd-UL-DL-ConfigurationCommon information element (IE) of system information block type 1 (SIB1)). This common slot configuration can also be provided using dedicated (e.g., radio resource control (RRC)) signalling (as illustrated at S710b) to specific UEs 3 within the cell (for example in a tdd-UL-DL-ConfigurationCommon IE of an RRC message such as an RRC reconfiguration message or the like). On receipt of the common slot configuration a UE 3 can thus set a common slot format configuration per slot over a number of slots (as seen at S712).

As seen in FIG. 8, which shows illustrative examples of slot configurations configured by the procedures of FIG. 7, the slots may be configured as downlink only slots, as uplink only slots, or as unallocated or ‘flexible’ slots (that may be downlink or uplink).

The common slot configuration is defined by a number of parameters provided by the base station 5 as part of a common UL/DL slot configuration. These parameters include: a slot configuration period (e.g., configured by a dl-UL-TransmissionPeriodicity IE); a number of slots with only downlink symbols (e.g., configured by a nrofDownlinkSlots IE); a number of downlink symbols (e.g., configured by a nrofDownlinkSymbols IE); a number of slots with only uplink symbols (e.g., configured by a nrofUplinkSlots IE); and a number of uplink symbols (e.g., configured by a nrofUplinkSymbols IE). As seen in FIG. 8, these effectively configure a repeating pattern of slot types (repeating at the slot configuration period), which in this example comprises DL only slots and symbols, followed by flexible slots and symbols, followed by UL only slots and symbols. The repeating pattern starts with a DL group comprising the defined number of DL only slots followed by the defined number of DL only symbols in the next slot. The repeating pattern ends with a UL group comprising the defined number of UL only slots preceded by the defined number of UL only symbols in the preceding slot. The flexible symbols and slots are those, between the DL group of DL only slots and symbols and the UL group of UL only slots and symbols.

As seen in procedure S714, the base station 5 of the communication system 1 is also configured for providing, if required, a dedicated (or ‘UE specific’) slot configuration for a specific UE 3. This dedicated slot configuration can be provided using dedicated (e.g., radio resource control (RRC)) signalling (as illustrated at S715) to a specific UE 3 within the cell (for example in a tdd-UL-DL-ConfigurationDedicated IE of an RRC message such as an RRC reconfiguration message or the like).

If a UE 3 is provided with the dedicated slot configuration in addition to the common slot configuration, then the dedicated slot configuration overrides only the symbols and slots configured as flexible symbols and slots, per slot, over the number of slots configured by the common slot configuration (as seen in the example of FIG. 7).

The dedicated configuration, if provided, includes one or more individual slot specific configurations (e.g., using a slotSpecificConfigurations ToAddModList IE) in which each slot configuration contains information (e.g., a slotindex IE) identifying a specific slot within the slot configuration period defined by the common slot configuration, and information defining a symbol structure (e.g., a symbols IE). The information defining the symbol structure provides the direction (downlink or uplink) for the symbols within the specific slot that is being configured. The information defining the symbols structure may, for example: indicate that all symbols in the specific slot are used for the downlink (e.g., by setting the symbols IE to ‘allDownlink’); indicate that all symbols in the specific slot are used for the uplink (e.g., by setting the symbols IE to ‘allUplink’); or explicitly indicate how many symbols at the beginning and the end of the specific slot are allocated to downlink and uplink, respectively (e.g., a nrofDownlinkSymbols IE may indicate the number of consecutive downlink symbols in the beginning of the slot identified by the slot index, and a nrofUplinkSymbols IE may indicate the number of consecutive uplink symbols at the end of the slot identified by the slot index).

A UE 3 can thus set a dedicated slot format configuration per slot over a number of slots (as seen at S716).

A UE 3 thus teats symbols in a slot indicated as downlink by the common slot configuration, or by the dedicated slot configuration, as being available for receptions. Similarly, a UE 3 teats symbols in a slot indicated as uplink by the common slot configuration, or by the dedicated slot configuration, as being available for transmissions.

Even after the slot configurations in a cell-specific and UE-specific manner described above, the slot configuration may have some more flexible slots/symbols left unallocated. By making use of layer 1 signalling, the remaining (if any) flexible symbols can be reconfigured dynamically.

As seen in procedure S718, for example, the base station 5 of the communication system 1 is also configured for providing one or more dynamic slot configurations to a group of one or more UEs 3 by means of a physical downlink control channel (PDCCH). One or more dynamic slot configurations can be provided using downlink control information (DCI) using an appropriate DCI format (e.g., DCI format 2_0), as illustrated at S719, to a specific group of one or more UEs 3 within the cell 9.

Indexes of one or more slot format indicators (SFIs) are provided within the payload of the DCI for the group of one or more UEs 3. To allow the DCI to be addressed to and decoded by one or more UEs 3 of the group, cyclic redundancy check (CRC) bits of the DCI are scrambled with an associated radio network temporary identifier (RNTI), for example a slot format indicator RNTI (′SFI-RNTI′) or the like. One or more UEs 3 in the group are allocated with the same RNTI. Each UE 3 of the group is configured to extract its own SFI-index based on the position of the SFI-index within the DCI payload (this position may, for example, be configured by UE specific RRC signalling). The RRC configuration may, for example, be by means of an RRC message carrying a PDCCH serving cell configuration IE having a slot format indicator (SFI) IE that, for a specific serving cell (identified by a serving cell ID (e.g., by a servingCellId IE)): provides an SFI-RNTI; defines one or more slot format combinations (e.g., by a slotFormatCombinations IE); and specifies the starting position (bit), in the DCI, of the SFI index that is applicable for the configured UE (e.g., by a positionInDCI IE).

Each SFI-index provided by the DCI acts as a pointer to a combination of slot formats (where each slot format corresponds to a respective combination of downlink, uplink, and/or flexible symbols) for defining a slot format for each slot in a number of slots starting from a slot where the UE detects the dynamic slot configuration DCI format.

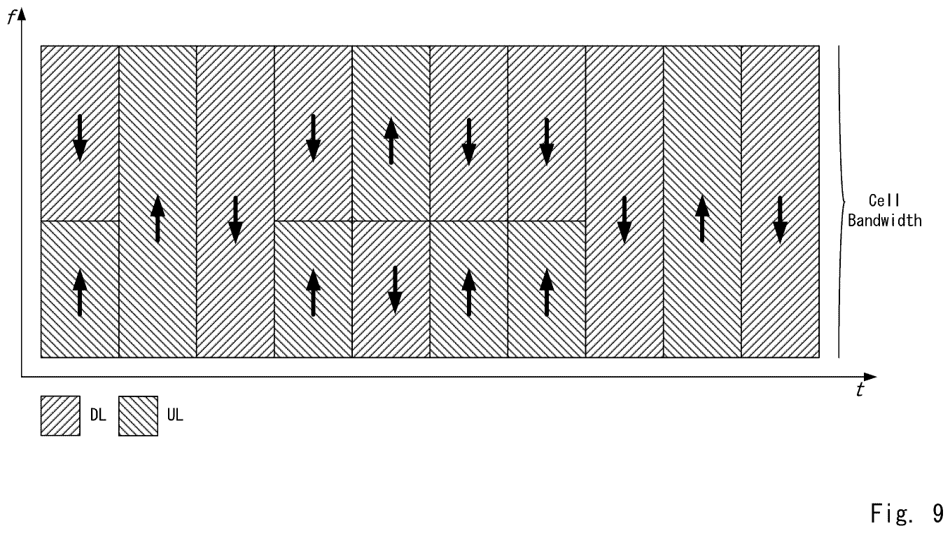

Thus, for any slot indicated to a UE 3 as flexible by both a common slot configuration and a dedicated slot configuration, the DCI can be used to dynamically configure downlink, uplink, and/or flexible symbols within that slot (as seen in the example of FIG. 9).

A UE 3 can thus set a dynamic slot format configuration per slot over a number of slots (as seen at S720).

### Bandwidth Parts (BWPs)

In the communication system 1 the cell bandwidth can be divided into multiple bandwidth parts (BWPs) that each start at a respective common resource block (RB) and respectively comprises of a set of contiguous RBs with a given numerology (sub-carrier spacing, ‘SCS’, and cyclic prefix, ‘CP’) on a given carrier. It will be appreciated that conventionally the number of downlink symbols, uplink symbols, and flexible symbols in each slot of the slot configuration (e.g., common or dedicated) would be common to each configured BWP.

The UEs 3 and base station 5 of the communication system 1 are thus configured for operation using BWPs. For each serving cell of a UE 3, the base station 5 can configure at least one downlink (DL) BWP (e.g., an initial DL BWP). The base station 5 may configure the UE 3 with up to a maximum (typically four) DL BWPs with only a single DL BWP being active at a given time. The UE 3 is not expected to receive PDSCH, PDCCH, or CSI-RS (except for radio resource management (RRM)) outside an active bandwidth part. Where the serving cell is configured with an uplink (UL), the base station 5 can configure at least one UL BWP (e.g., an initial UL BWP). The base station 5 may configure the UE 3 with up to a maximum (typically four) UL BWPs with only one UL BWP being active at a given time. The UE 3 does not transmit PUSCH or PUCCH outside an active bandwidth part. For an active cell, the UE 3 does not transmit SRS outside an active bandwidth part. It will be appreciated that the slot format indicator (e.g., an SFI-index field value) in the dynamic slot configuration DCI format may indicate to a UE 3 a slot format for each slot in a number of slots for each DL BWP or each UL BWP.

A BWP identifier or index (BWP-ID) is used to refer to BWPs (in UL and DL independently). Various radio resource control (RRC) configuration procedures can thus use the BWP-ID to associate themselves with a particular BWP.

While for paired spectrum (FDD), DL BWPs and UL BWPs are configured separately, for unpaired spectrum (TDD), a DL BWP is effectively linked to (paired with) a UL BWP, with the paired DL BWP and UL BWP sharing the same BWP-ID and centre frequency (but possibly different bandwidths).

Specifically, the base station 5 is able to configure an initial DL BWP (e.g. by means of an initialDownlinkBWP IE) via system information (e.g. system information block 1, ‘SIB1’) and/or via dedicated (e.g. RRC) signalling (e.g. an RRC reconfiguration, RRC resume, or RRC setup message). For example, the common parameters for the initial DL BWP may be provided via system information whereas UE specific parameters may be provided via dedicated signalling (e.g. in a ServingCellConfig 1E within an RRC message that contains a dedicated, UE-specific, BWP configuration). The dedicated signalling may also contain some cell-specific information which may be useful for specific scenarios (e.g. handover).

The base station 5 is able to configure an initial UL BWP (e.g. by means of an initialUplinkBWP IE) via system information (e.g. system information block 1, ‘SIB1’) and/or via dedicated (e.g. RRC) signalling (e.g. an RRC reconfiguration, RRC resume, or RRC setup message). For example, the common parameters for one or more initial UL BWPs may be provided via system information whereas UE specific parameters may be provided via dedicated signalling (e.g. in a ServingCellConfig 1E within an RRC message that contains a dedicated, UE-specific, BWP configuration). This provides configuration information either for a so-called special cell (SpCell)—which is a primary cell (PCell) of a master cell group (MCG) or secondary cell group (SCG)—or a secondary cell (SCell).

The initial DL and UL BWPs are used at least for initial access before an RRC connection is established. The initial BWP is known as BWP #0 as it has a BWP identifier (or ‘index’) of zero. Prior to receiving system information defining a UE's initial DL BWP, the DL BWP for each UE 3 has a frequency range and numerology corresponding to a control resource set (CORESET)—e.g. CORESET #0—defined by a master information block (MIB) (or possibly dedicated RRC signalling). The CORESET is used to carry downlink control information (DCI) transmitted via a PDCCH for scheduling system information blocks.

After receiving the system information (e.g. SIB1) a UE 3 uses the BWP configuration defined by that system information to configure the initial DL BWP and initial UL BWP. The configured initial UL BWP is then used to initiate a random-access procedure for setting up an RRC connection. The base station 5 configures the frequency domain location and bandwidth of the initial DL BWP in the system information so that the initial DL BWP contains the entire CORESET #0 in the frequency domain.

For each DL BWP in a set of DL BWPs for a primary cell (PCell), a UE 3 can be configured with CORESETs for every type of common search space (CSS) set (sometimes referred to as a cell-specific search space (CSS)) and for a UE-specific search space (USS) set. For each UL BWP in a set of UL BWPs of a PCell, or of a PUCCH-secondary cell, the UE 3 is configured resource sets for PUCCH transmissions.

The UE 3 is configured for switching its active BWP between its configured BWPs when required. For example, switching at the UE 3 may be initiated by receipt of a scheduling DCI, by expiry of an inactivity timer (e.g., a BWPInactivity Timer), and/or by initiation of a random-access procedure.

### Provision of Full Duplex

The UEs 3 and base station 5 of the communication system 1 are mutually configured for providing full duplex (FD) communication on a TDD carrier. Specifically, the UEs 3 and base station 5 of the communication system 1 are configured to facilitate subband non-overlapping FD (SBFD) communication.

For example, as seen in FIG. 9, which is a simplified time frequency diagram showing an illustrative example of a full duplex configuration that may be used in the communication system 1, the different UE specific slot configurations allow a slot within the cell bandwidth to effectively be configured as an FD slot by configuring that slot for one UE as an uplink slot, while the same slot is configured as a downlink slot for another UE (or vice versa). Thus, UL communication from one UE 3 in the cell bandwidth may occur in parallel with DL communication to another UE 3. It will be appreciated that while not specifically illustrated the parallel UL/DL communication may be configured at a symbol level as well as at the slot level.

It will be appreciated that the base station 5 is configured to schedule frequency resources of any slot configured as an FD slot, to ensure that the frequency resources scheduled for UL communication by one UE 3 are part of a different subband than the frequency resources scheduled for DL communication to another UE 3. Accordingly, subband non-overlapping FD communication can thus take place at the base station 5 while half-duplex communication takes place at the UEs 3.

The base station 5 is thus able to configure one or more of the slots (and/or symbols) of the TDD carrier as FD slots (and/or symbols) or more specifically, in a case where, subband non-overlapping full duplex (SBFD) is used for full duplex operation, SBFD slots (and/or symbols). For convenience, slots/symbols which contain both UL and DL subbands, from the base station's perspective, will be referred to generally as ‘SBFD’ slots/symbols, or slots/symbols with a configured UL subband/DL subband. Other slots/symbols, which only contains communication in a single transmission direction (UL or DL) will generally be referred to as legacy (UL or DL) slots/symbols or non-SBFD (UL or DL) slots/symbols.

It will be appreciated that, from a UE perspective, an SBFD slot or symbol may appear to be a legacy UL, DL, or flexible symbol because the UE 3 is operating using half duplex on the TDD carrier. Nevertheless, a UE 3 may be informed of the FD/SBFD slots/symbols, either implicitly or explicitly, to allow the UE 3 to assist with interference avoidance/alleviation. For example, if the UE 3 can identify the FD/SBFD slots/symbols then the UE 3 may: contribute to the implementation of an appropriate frequency gap between the frequency resources used by that UE 3 (e.g., for UL or DL) and the frequency resources used by another UE 3 (e.g., for DL or UL); avoid, reconfigure, and/or apply updated resources, in respect of certain transmissions/receptions (e.g., for semi-static transmission such as SPS).

For example, the base station 5 may explicitly indicate which slots/symbols are configured as FD/SBFD type slots/symbols, for example, dynamically using DCI with an appropriate DCI format and/or using a Medium Access Control (MAC) Control Element (CE). The base station 5 may, alternatively or additionally explicitly indicate which slots/symbols are configured as FD/SBFD type slots/symbols via system information or dedicated (RRC) signalling (for example, by means of frame structure signalling similar to that used for the cell specific and/or dedicated TDD UL/DL slot configuration). A UE 3 may implicitly determine whether a slot/symbol is configured as an FD/SBFD type slots/symbol based on other information received from the network (base station 5). For example, the UE may assume that an SBFD slot occurs when the RAN indicates that an UL transmission is to take place during a DL configured slot or that a DL transmission is to take place during a UL configured slot.

It will be appreciated that there are different variations which exist for implementation of SBFD, and the communication system 1 may be configured to provide support for any suitable SBFD schemes. Such schemes may include, for example, inter-BWP full duplex and/or intra-BWP full duplex.

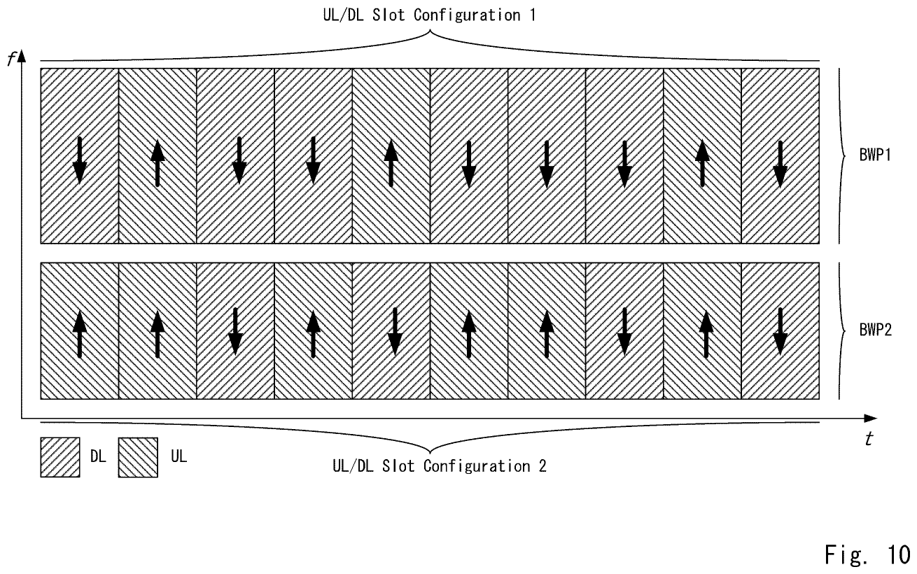

Referring to FIG. 10, for example, which is a simplified time frequency diagram showing an illustrative example of an inter-BWP type of full duplex configuration, inter-BWP full duplex involves parallel UL and DL transmission in different BWPs in which a particular slot of one BWP may be configured as an uplink slot while the corresponding slot (i.e., having the same timing) in another BWP may be configured as a downlink slot (or vice versa). Thus, UL from one UE 3 in one BWP may occur in parallel with DL communication to another UE 3 in another BWP.

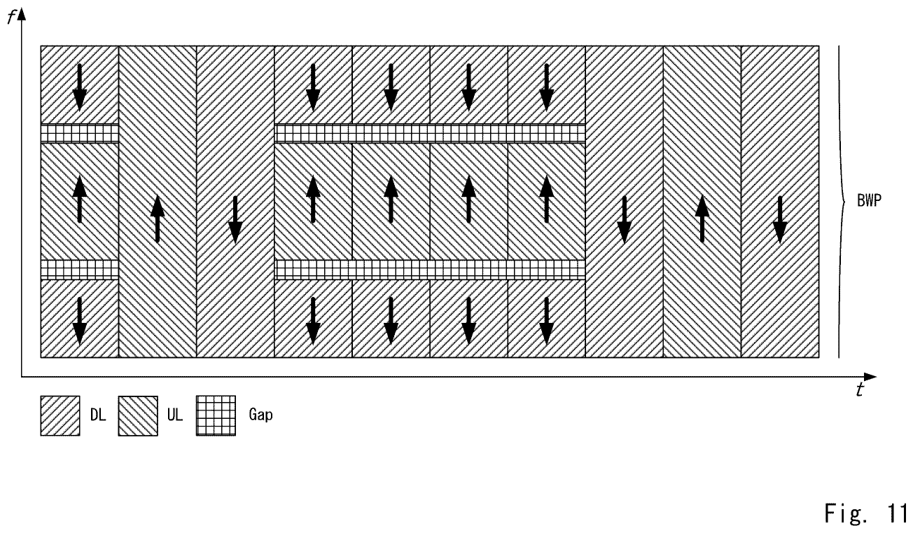

Referring to FIG. 11, on the other hand, which is a simplified time frequency diagram showing an illustrative example of an intra-BWP type of full duplex configuration, intra-BWP full duplex involves parallel UL and DL transmission in the same BWP. In the example illustrated in FIG. 11, an UL subband is effectively inserted/configured within a slot/symbol configured as a (legacy) DL or flexible slot/symbol of a BWP. Specifically, each time resource of the BWP is configured as a DL, a UL, or a flexible slot/symbol (for example using a TDD configuration technique as described with reference to FIGS. 7 and 8). An UL subband (e.g., a set of contiguous UL frequency resources) is then configured within the BWP for at least a subset of one or more of the DL or flexible slots/symbols to effectively form a slot/symbol that consists of a UL subband and one or two DL subbands. The configuration of one or more UL subbands may be achieved in any suitable way, for example by semi-static configuration and/or dynamic configuration. A guard band (frequency gap) may be configured, between the UL subband and each DL subband, where no transmission is performed, thereby helping to avoid interference. The base station 5 can then schedule UL transmission in the UL subband and DL transmission in one or more DL subbands as necessary.

It will be appreciated that the base station may also be able to schedule DL transmission within UL subband dynamically (e.g., when there is no UL transmission required to improve radio resource utilization).

It will also be appreciated that while FIG. 11 shows a UL subband being inserted in a downlink or flexible slot/symbol, a similar mechanism may also be used to insert a DL subband within an UL or flexible slot/symbol to achieve SBFD.

Notwithstanding that an UL (or DL) subband may be configured in a slot/symbol configured (e.g., by a TDD configuration) as a DL (or UL) slot/symbol, it will be appreciated that it would be particularly beneficial for the base station 5 to be able to schedule DL (or UL) transmission within a configured UL (or DL) subband dynamically (for example, when there is no UL (or DL) transmission required) to improve radio resource utilization.

Slots/symbols which contain both a UL and a DL subband may be referred to as SBFD slots/symbols or more generally to slots/symbols with configured UL subband/DL subband. Other slots/symbols for a single transmission direction (UL or DL) may be referred to as non-SBFD slots/symbols.

### Communication in Unlicensed Spectrum

The UEs 3 and base station 5 of the communication system 1 are mutually configured for communication in unlicensed spectrum.

For DL transmissions, the base station 5 is able to select an appropriate LBT procedure based on the duration of COT required (which determines the maximum transmission duration) and hance the type of transmission that can be performed in the COT. For example, an SSB transmission may be performed using Type-2 due to it having a relatively short transmission duration, whereas a longer transmission may require use of Type-1 LBT.

For UL transmissions, the base station 5 typically indicates, to a UE 3, the type of LBT procedure to be performed by that UE 3. An LBT type for a PUSCH, for example, may be provided within an UL grant during, e.g., during an initial access (random access channel, ‘RACH’) procedure. For configured grant (CG UL), the UE 3 will typically use Type-1 LBT. For a PUCCH and/or a PRACH without a PUSCH, the UE 3 will typically use Type-1 LBT with a CAPC set to 1 (p=1). For DL triggered SRS, the UE 3 typically uses Type-2 LBT but, otherwise, may use Type-1 LBT with a CAPC set to 1 (p=1). Multiple LBT points are provided for an UL transmission, thereby allowing a UE 3 to successfully perform UL transmission whenever the channel access procedure is successful.

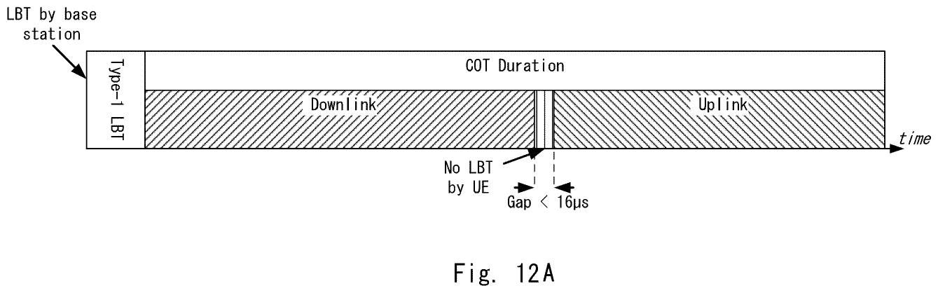

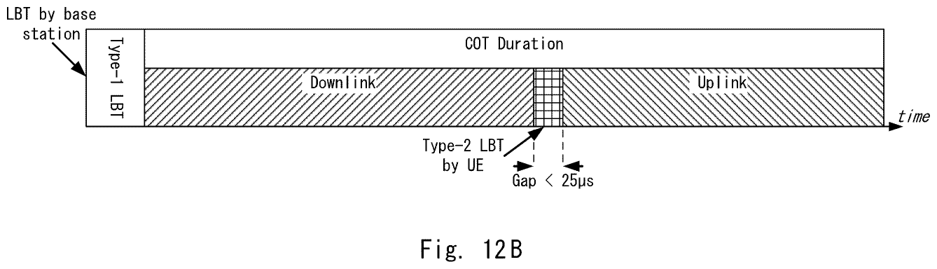

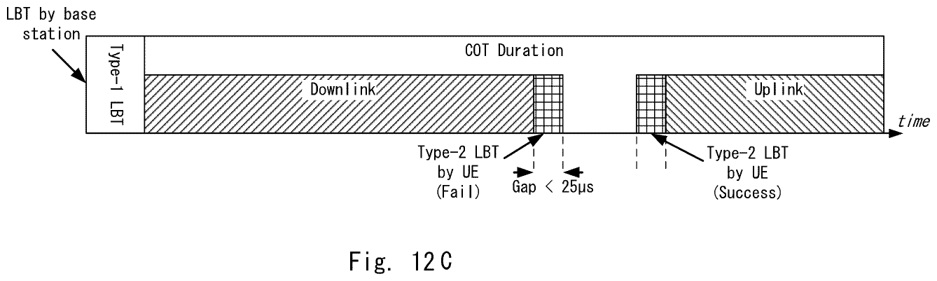

The UEs 3 and base station 5 of the communication system 1 are also configured for COT sharing. Various examples of COT sharing are illustrated in FIGS. 12A to 12C.

For example, if a base station 5 acquires a COT, then the base station 5 is able to share this COT with a UE 3 to allow the UE 3 to perform an UL transmission within the COT duration. Similarly, when a UE 3 initiates a COT, it may share the COT with the base station 5 for a DL transmission. In the context of COT sharing, the base station 5 may indicate the value of the COT structure and its duration to the UE 3 using dynamic signalling (e.g., DCI using an appropriate DCI format (such as DCI format 2_0).

As illustrated in FIGS. 12A to 12C, during an ongoing COT, if the transmission direction needs to change from UL to DL or DL to UL, then an additional LBT procedure may need to be performed depending on the transmission gap.

If the gap is less than 16 μs, then LBT need not be performed (i.e., Type 2C) as shown in FIG. 12A. The duration of the corresponding transmission is restricted to a maximum of 584 μs and is only allowed for a single transmission direction change within the COT.

If the gap is between 16 μs and 25 μs, then a Type-2A/B LBT procedure may be performed (as seen in FIG. 12B). Otherwise, a Type-1 LBT procedure can be used.

As seen at FIG. 12C if an LBT is unsuccessful, a subsequent attempt may be made if there is sufficient time of the COT duration left. If the subsequent LBT is successful, then transmission may occur within the remaining COT.

### Resource Allocation

The UEs 3 and base station 5 of the communication system 1 are also mutually configured to support a number of different resource allocation schemes/types to allow the frequency-domain resources for transmission and reception to be determined. Typically, the base station 5 allocates the frequency resources are to the UE 3, by means of signalling carrying a resource-block allocation field (carrying resource allocation information from which the identity of the allocated physical resource blocks within the active BWP), and a bandwidth part indicator (indicating the active BWP the allocated resources form part of).

The schemes supported in the communication system 1 include, but are not limited to, a Type 0 allocation, a Type 1 allocation, and a Type 2 allocation. Resource allocation Type 0 and Type 1 correspond broadly to corresponding schemes defined by the 3GPP standards for LTE (in which the resource block allocation is signalled across the carrier) and (with some minor changes) for 5G (in which the resource block allocation is signalled for the active BWP). In the interests of brevity these schemes will not be described in detail.

Unlike the Type 0 and Type 1 allocations (in which allocated resource blocks are contiguous), Type 2 allocation, provides an “interlaced” resource allocation for UL communications. For interlaced UL resource allocation, the basic unit of resource allocation is an interlace, which comprises a set of (e.g., five or ten) equally spaced (in frequency) resource blocks within the bandwidth (e.g., 20 MHz) for a particular sub-carrier spacing (e.g., 30 KHz or 15 KHz). Multiple interlaces of RBs may be defined where an interlace m∈{0, 1, . . . , M?1} consists of common RBs {m, M+m, 2M+m, 3M+m, . . . }, with M being the number of interlaces (e.g., five for a sub-carrier spacing of 30 KHz or ten for a sub-carrier spacing of 15 KHz). For a given interlace, m, and sub-carrier spacing, the relationship/mapping between the index/number (nIRB) of an interlaced resource block (IRB) and the corresponding index/number a (nCRB) of a common resource block (CRB) number is broadly given by the following equation.

$${n}_{CRB} = {Mn}_{IRB , m} + {N}_{BWP}^{start} + ( ( m - {N}_{BWP}^{start} ) mod M ) \qquad ( Equation 1 )$$

$${N}_{BWP}^{start}$$

is the common resource block where bandwidth part starts relative to common resource block 0, and the interlaced resource block in the bandwidth part of

$${n}_{IRB , m}^{μ} ∈ \{ 0 , 1 , … \}$$

interest.

In uplink resource allocation of type 2, the resource block allocation/assignment information indicates to the UE 3 a set of up to M (as defined above) interlace indices, and may indicate a set of contiguous sets of resource blocks (RB sets)—up to the maximum possible number of RB sets in the corresponding BWP. An assigned physical resource block is mapped to virtual resource block within the active UL BWP. Where one or more RB sets are indicated, the UE 3 may determine the resource allocation in frequency domain as an intersection of the resource blocks of the indicated interlaces, and the union of the indicated set of RB sets and any intra-cell guard bands. For a common search space, the UE may determine the resource allocation in frequency domain as an intersection of the resource blocks of the indicated interlaces and a single uplink RB set of the active

UL BWP (which may, for example, be the lowest indexed RB set amongst one or more uplink RB sets that intersects with the lowest-indexed control channel element (CCE) of the PDCCH in which the UE 3 detects the downlink control information in the active downlink BWP).

Interlaced Resource Allocation in the Context of Unlicensed Spectrum In the context of unlicensed spectrum, interlaced resource allocation may be defined for UL transmissions to help ensure that the UL transmissions can meet any occupied channel bandwidth requirement imposed by regulations. Generally, interlaced resource allocation is applicable for UL transmissions whereas, for DL transmissions, network-based scheduling would normally be sufficient to ensure the occupied channel bandwidth requirement.

For wideband unlicensed operation, the communication system 1 supports a serving cell/BWP with bandwidth larger than 20 MHz. For a cell/BWP bandwidth that is greater than 20 MHz, then multi-channel LBT operations may be used in which LBT is performed on each of a plurality of (typically 20 MHz) LBT bandwidths contained within the cell/BWP bandwidth before initiating transmission on the entire bandwidth of the BWP.

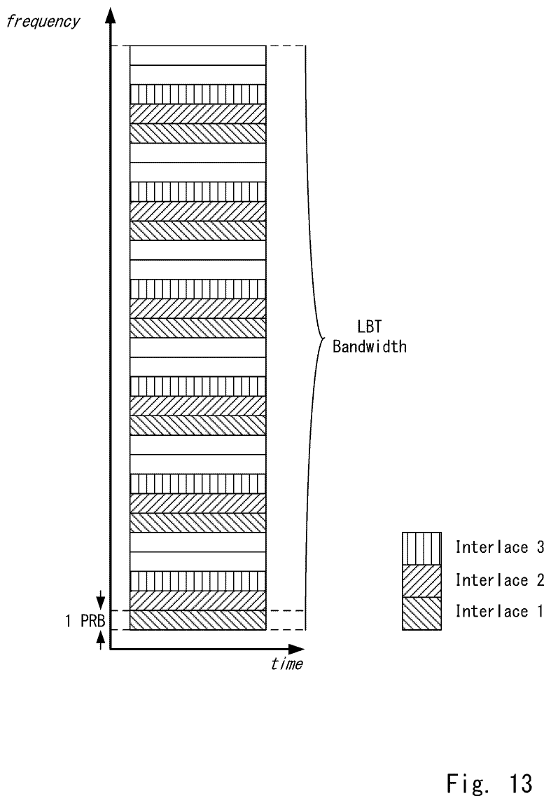

FIG. 13 shows an example of an interlaced resource allocation in an unlicensed band. As seen in FIG. 13, there are three allocated interlaces spanning a particular LBT bandwidth (e.g., 20 MHz).

### SBFD in Unlicensed Spectrum (SBFD-U)

Beneficially, the UEs 3 and base station 5 of the communication system 1 are mutually configured for SBFD communication using an unlicensed channel whilst taking account of the various regulatory and/or other constraints on the use of unlicensed spectrum.

Specifically, the communication system 1 supports SBFD communication using an unlicensed channel in accordance with one or more methods or techniques as described below. Whilst a number of different methods/techniques are described, it will be appreciated that they are neither mutually exclusive nor dependent on the presence of one another. For example, different techniques for implementing SBFD UL and DL sub-bands in an unlicensed channel and/or the different techniques for performing LBT may be supported by the same base station/UE for use, as appropriate, depending on configuration.

In one beneficial method described in more detail later, in order to help address the channel occupancy requirement, the frequency resource allocation for each UL subband and each DL subband is distributed over substantially an entire cell/BWP unlicensed bandwidth. Specifically, the frequency resource allocation, for both UL and DL subbands for SBFD, uses an interlaced structure to distribute the resources across the entire unlicensed spectrum for which the LBT procedure is required (‘LBT bandwidth’), for example distributed from the lowest frequency (or somewhere within the lowest frequency portion (e.g., the bottom 10%) of the bandwidth) to the highest frequency (or at least somewhere within the highest frequency portion (e.g., the top 10%) of the bandwidth).

It will be appreciated that, in previously proposed SBFD implementations, there is no specified transmission gap between DL communication and UL communication within which the UE 3 can sense the channel (perform LBT) because, for SBFD, DL transmission may continue when an UL transmission starts.

As described in more detail later, in one beneficial technique for addressing this that may be supported in the communication system 1, in the context of unlicensed spectrum, the UE 3 is allowed to share a COT previously acquired by the base station 5 without performing an LBT (i.e., following a Type 2C LBT/channel access procedure) to gain access to the unlicensed channel (e.g., in the event that DL transmission is ongoing when an UL transmission is expected to commence).

As described in more detail later, in another beneficial technique that may, alternatively or additionally, be supported in the communication system 1, to allow the UE 3 to sense interference before initiating an UL transmission (e.g., for Type-2 LBT), the transmissions in the DL subband are stopped temporarily for a ‘guard’ or ‘LBT’ period (that may be shorter than the requirements for a Type-2 LBT procedure). It will be appreciated that in this case a Type 2C LBT/channel access procedure—i.e., without preforming an LBT—may still be performed at the UE 3 where appropriate.

In the method in which the frequency resource allocation, for both UL and DL subbands for SBFD, uses an interlaced structure there is a potential for increased self-interference at the base station 5. This is because the interlace based segregation of the DL and UL subbands may not allow implementation of analog filters at the base station 5. However, it will be appreciated that self-interference may be mitigated in other ways and, in any case, the benefits of this method may outweigh any disadvantage associated with self-interference.

Nevertheless, as described in more detail later, in another beneficial method for helping to address the channel occupancy requirement that may, alternatively or additionally, be implemented in the communication system 1, the LBT bandwidth may be treated as if it is divided into separate (contiguous) LBT subbands that each comprise a set of one or more RBs (e.g., an RB set of the contiguous RB sets referred to above in the context of Type 2 resource allocation). SBFD is then implemented in a manner in which each LBT subband may respectively contain one or more UL subbands, or one or more DL subbands, but not both.

As described in more detail later, in a scenario in which the LBT bandwidth is divided into separate LBT subbands and each LBT subband respectively contains an UL subband, or a DL subband, any of a number of different LBT techniques may beneficially be implemented, in the communication system 1, to allow the base station 5 and UE 3 to access a channel on the unlicensed spectrum when needed.

In one beneficial technique, for example, the base station 5 is configured to perform LBT for all of the LBT subbands (including one or more LBT subbands associated with a UL subband). When LBT is successful, the base station 5 can then indicate the acquired COT to the UE 3, which can then perform Type-2 LBT to access and share the COT. In another beneficial technique which may, alternatively or additionally, be supported in the communication system 1, the base station 5 performs LBT for only the LBT subbands associated with one or more DL subbands of the SBFD configuration. The base station 5 can, in this case, send an indication (e.g., of the acquired COT duration) to the UE 3 to trigger the UE 3 to perform Type-1 LBT for one or more LBT subbands associated with one or more UL subbands of the SBFD configuration.

Beneficially, as described in more detail later, in another beneficial method for helping to address the channel occupancy requirement that may, alternatively or additionally, be supported by the communication system 1, the base station 5 and UE 3 are able to configure both the DL and the UL subbands for SBFD operation over an unlicensed channel within the same LBT bandwidth, in a similar manner to the way in which they would be configured for operation in licensed spectrum (i.e., using contiguous rather than interlaced resources for each DL or UL subband). However, in this method appropriate restrictions (e.g., on the size of the UL bandwidth relative to the LBT bandwidth, and/or one or more other conditions, for which SBFD operation is allowed) are imposed to ensure that the SBFD operating base station 5 can coexist without causing interference to any other nodes/technologies in the vicinity.

In most cases, the channel access (LBT) procedure for SBFD operation will likely be different than the channel access (LBT) procedure that would be used for legacy systems. Beneficially, therefore, for scenarios in which SBFD operation is used in a configuration in which both legacy DL/UL (non-SBFD) slots/symbols and SBFD slots/symbols are included, the base station 5 and UE 3 of the communication system 1 may be configured to use a type of channel access procedure and/or one or more channel access parameters that are dependent on the slot/symbol type (e.g., to allow a different type of LBT procedure to be performed for legacy DL/UL (non-SBFD) slots/symbols than is performed for SBFD slots/symbols).

### Interlaced Allocation for SBFD in Unlicensed Spectrum

As mentioned above, in one beneficial method, to help address the channel occupancy requirement for using unlicensed spectrum, the frequency resource allocation, for each UL subband and each DL subband of a time resource (slot/symbol) configured for SBFD, is distributed over an entire LBT bandwidth.

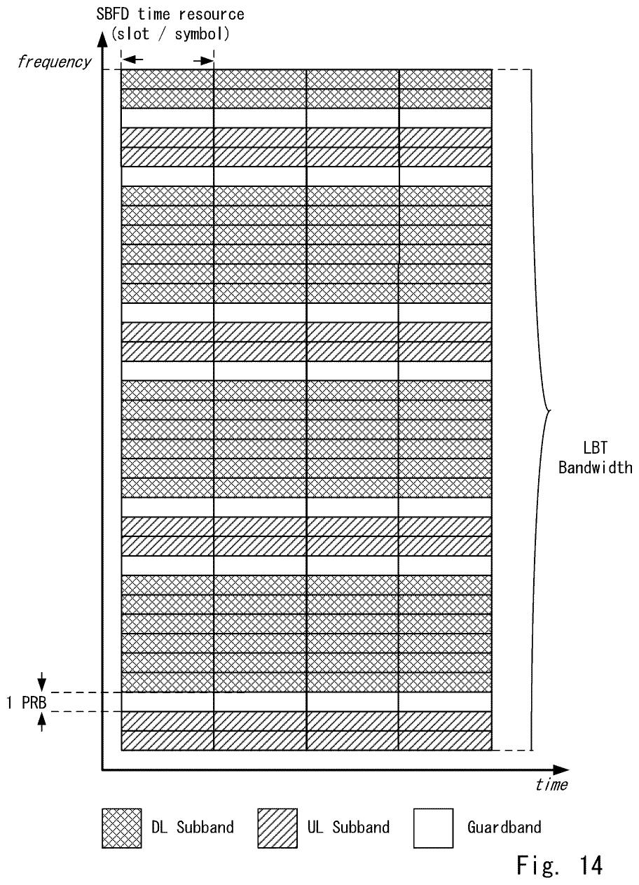

FIG. 14 is a simplified time frequency diagram illustrating, by way of example only, an interlaced allocation of resources for downlink and uplink subbands that may be supported in the communication system 1. It will, nevertheless, be appreciated that any suitable interlace type allocation may be applied.

As seen in FIG. 14, for SBFD time resources, the DL subband resource allocation and UL subband resource allocation respectively take the form of a pattern of frequency resources (e.g., resource blocks) that repeats (periodically in the frequency domain) over the entire bandwidth of the cell/BWP. Each of these patterns is in essence, therefore, a form of interlace.

As those skilled in the art will appreciate, the frequency resource allocation for the DL and/or UL subband can be configured by the base station 5 to the UE 3 in different ways. In one example the base station 5 signals a set of N interlaces (where N can be one or more) to the UE 3 for the DL and/or UL subband, where each of the N interlaces consists of frequency resources or resource blocks {m, m+M, m+2M, m+3M, . . . } where m is the starting frequency resource or resource block of the interlace and M is a configurable or pre-defined parameter. Here, for each of the N interlaces configured for the DL and/or UL subband, the base station 5 may respectively indicate to the UE 3 the value of m and M (unless M is pre-defined or otherwise already known to the UE 3 implicitly).

In another example, the base station 5 may configure the UE 3 with a set of parameters for the DL and/or UL subband, typically at least three (integer) parameters m, L, and M, where the frequency resource allocation of the DL and/or UL subband is interpreted by the UE 3, based on the parameters as follows:
The first set of frequency resources (P1) for the DL and/or UL subband are m, m+1, m+2, . . . , m+L−1 (corresponding to ‘L’ consecutive frequency resources starting from the mth frequency resource)
The remaining set of frequency resources are determined by repeating the pattern formed by the first set of frequency resources (P1) with a frequency interval of M i.e. {P1, P1+M, P1+2M, . . . }

Similarly, the guard band or unused frequency portion is also a form of interlace. It will be appreciated that the guard band can be configured explicitly by the network (e.g., by one or more dedicated information elements in one or more messages from the base station). Nevertheless, the location of the guard band ‘interlace’ may be configured implicitly. For example, the UE and/or base station may determine the frequency resources to be left unused (i.e., of the guard band) based on the allocation of frequency resources for one or more UL subbands and/or DL subbands (e.g., to ensure an appropriate frequency gap between uplink and downlink transmissions).

In the illustrated example, the frequency resources of one or more uplink subbands comprise an ‘uplink interlace’ in which a pair of contiguous resource blocks is repeated every ten resource blocks in the frequency domain. The frequency resources of one or more downlink subbands comprise a ‘downlink interlace’ in which a group of six contiguous resource blocks is repeated every ten resource blocks in the frequency domain. The frequency resources of the guard bands comprise a ‘guard band interlace’ in which a single unused resource block is repeated every ten resource blocks in the frequency domain at a location between the frequency resources allocated for the UL and the frequency resources allocated for the DL. It will be appreciated that the UL interlace may be considered, conceptually, to be a plurality (in this example a pair) of adjacent or contiguous interlaces. Similarly, that the DL interlace may be considered, conceptually, to be a plurality of (in this example up to six) adjacent or contiguous interlaces.

It will be appreciated by those skilled in the art that, conventionally, interlaced ‘Type 2’ resource allocation has not been supported for DL resource allocations.

In order to support DL transmission using interlaced resources, the base station 5 may be configured to rate match DL transmissions around resources that do not form part of the DL subband (e.g., around the resources of one or more UL interlaces and resources of the guard band). Alternatively (or possibly additionally), the base station 5 may be configured to use a DL resource allocation that is explicitly defined in terms of one or more interlaces where the index(es) of one or more interlaces may be selected from interlaces that are present within the configured DL subband.

For UL transmissions, the base station 5 configures (and the UE 3 uses) a resource allocation defined in terms of one or more interlaces where one or more indexes of the one or more interlaces may be selected from interlaces that are present within the configured UL subband.

It will be appreciated that whilst FIG. 14 only illustrates SBFD slots, advantageously, a different respective interlace structure may be configured: for UL-only symbols/slots; for DL-only symbols/slots; and/or for SBFD symbols/slots (e.g., to help optimise channel occupancy for the unlicensed channel).

UL Transmission without LBT for SBFD in Unlicensed Spectrum

As mentioned above, in one beneficial technique, the UE 3 is allowed to share a COT previously acquired by the base station 5 without performing an LBT (i.e., following a Type 2C LBT/channel access procedure) to gain access to the unlicensed channel (e.g., in the event that DL transmission is ongoing when an UL transmission is expected to commence).

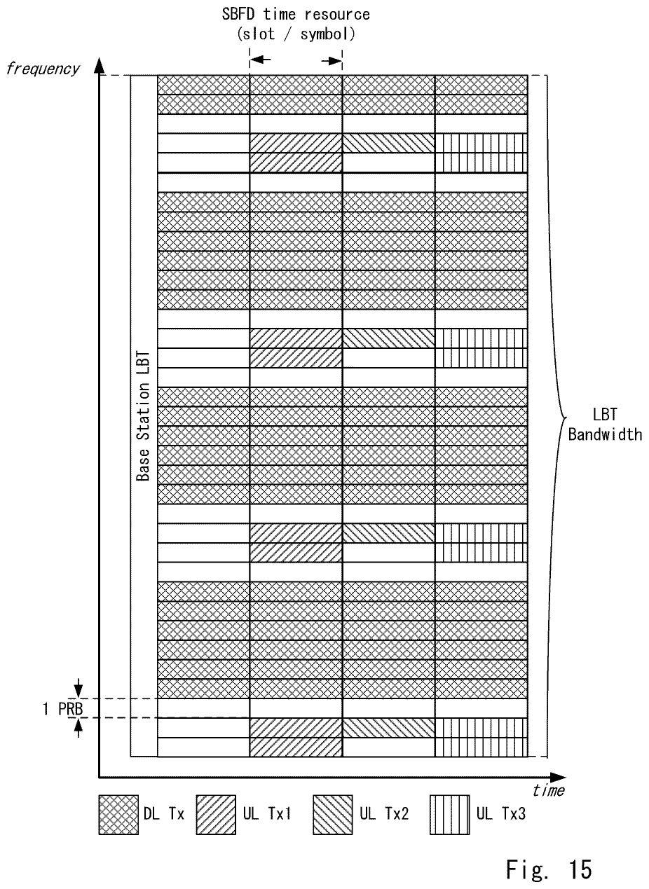

FIG. 15 is a simplified time frequency diagram illustrating, by way of example only, how LBT may be implemented for UL communication in the communication system 1. In the example of FIG. 15, the LBT technique is illustrated in the context of an interlaced SBFD resource allocation similar to that illustrated and described with reference to FIG. 14.

As seen in FIG. 15, three different UL transmissions take place (UL Tx1, UL Tx2, UL Tx3) during a COT acquired for the DL by the base station 5 following a successful LBT of an appropriate type (e.g., a Type 1 LBT). In the illustrated example, the UL transmissions are allowed to take place without the transmitting UE 3 (the transmissions may be from different UEs or from the same UE) being required to perform LBT and hence DL transmission can continue uninterrupted.

To reduce the risk of conflict with other devices/other technologies in the vicinity certain restrictions or conditions may be imposed on when no LBT has to be performed (i.e., Type 2C LBT is performed) by a UE 3 to access the unlicensed channel for UL transmission.

For example, no LBT (Type 2C LBT) may be performed for UL transmissions within an UL subband, at the time when UL transmission is expected to start, based on one or more of the following conditions:
UL transmission without LBT (Type 2C LBT) within an UL subband can be used subject to a limit on the (total) UL transmission duration (and/or number of UL transmissions) within the base station acquired COT. For example, if the UL transmission duration is less than a specific maximum ‘X’ (which may be a default value preconfigured in the UE and/or a value (pre) configured by the network), then UL transmission without LBT is allowed;
UL transmission without LBT (Type 2C LBT) within an UL subband can be used by a limited set of one or more UEs that are each respectively associated with the same directional beam that is used by the base station 5 to perform LBT and/or DL transmission; and/or
UL transmission without LBT (Type 2C LBT) within an UL subband can be used subject to the base station 5 LBT used to acquire the COT being a Type-1 LBT for a DL transmission/bearer having a priority/CAPC associated with the longest contention window period.

It will, nevertheless, be appreciated that these conditions are purely exemplary and that, UL transmission without LBT (Type 2C LBT) may be performed for other UL transmissions, based on one or more other conditions where appropriate, even if none of the above specific conditions are met.

UL Transmission with LBT for SBFD in Unlicensed Spectrum

As mentioned above, in another beneficial technique that may be supported in the communication system 1, the transmissions in the DL subband are stopped temporarily to effectively provide a ‘guard’ or ‘LBT’ period within which the UE may perform LBT (e.g., Type 2A or Type 2B LBT).

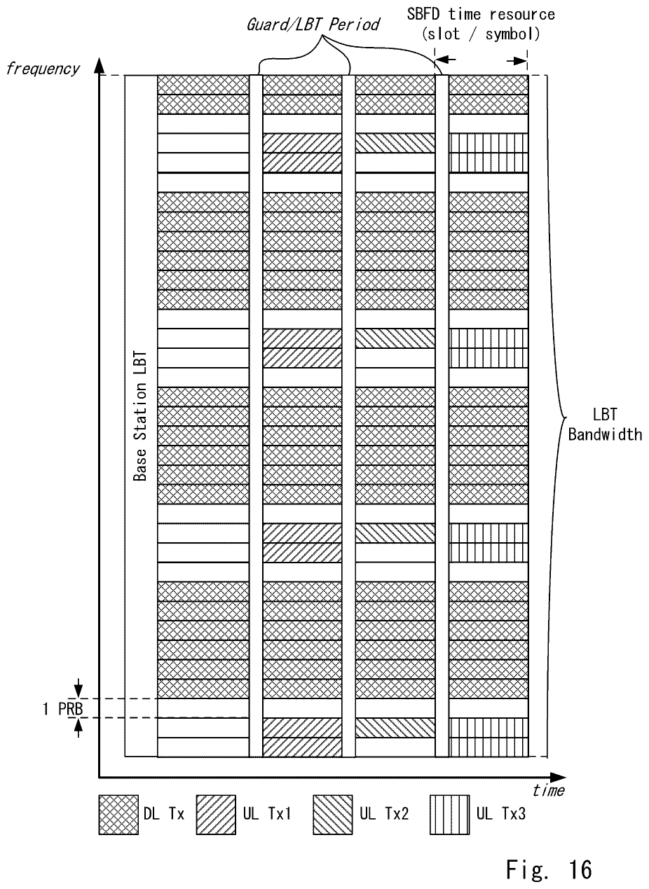

FIG. 16 is a simplified time frequency diagram illustrating another example of how LBT may be implemented for UL communication in the communication system 1. In the example of FIG. 16, the LBT technique is illustrated in the context of an interlaced SBFD resource allocation similar to that illustrated and described with reference to FIG. 14.

In this example, to allow the UE 3 to sense interference before initiating UL transmission (e.g., for Type-2 LBT), DL transmissions are stopped temporarily. Specifically, the base station 5 implements a ‘guard’ period or ‘LBT’ period, at an appropriate timing, during which it ceases DL transmissions temporarily. The timing may be fixed, or may be configurable, e.g., relative to the subframe/slot/symbol boundaries. The timing may, for example, be defined such that the DL guard period occurs just before the start of UL transmission instances (e.g., at the start of each slot during which UL transmission may occur, or at an appropriate symbol (e.g., the 7th symbol of a slot or subframe)).

In this example, the base station 5 may be configured to organise the DL transmissions such that each guard period occurs between two separate DL transmissions. Nevertheless, the base station 5 may, alternatively or additionally, be configured for introducing a guard period during an ongoing DL transmission, for example by puncturing the DL transmission with the guard period/UL LBT and, if necessary, performing appropriate rate matching around the punctured resources.

Any UEs receiving the DL transmission are informed, by the base station 5, of one or more configured time durations during which DL transmission will not be performed, for example by means of a rate matching/puncturing pattern and/or by providing a DL time resource indication.

The length of guard/LBT period is configured to be no greater than the maximum provided for by the requirements for a corresponding Type-2 LBT procedures (e.g., <16 us or <25 μs). It will be appreciated that a Type 2C LBT/channel access procedure—i.e., without preforming an LBT—may still be performed at the UE 3 where appropriate (e.g., for a gap less than 16 us and potentially subject to other conditions).

It will be appreciated that, in this example, any DL LBT is still performed during an appropriate transmission gap.

### LBT Subband to UL/DL Subband Mapping for SBFD

As mentioned above, in another beneficial method the LBT bandwidth may be treated as if it is divided into separate (contiguous) LBT subbands that each comprise a set of one or more RBs (e.g., an RB set of the contiguous RB sets referred to above in the context of Type 2 resource allocation), and SBFD may be implemented in a manner in which each LBT subband/RB set may respectively contain one or more UL subbands, or one or more DL subbands, but not both.

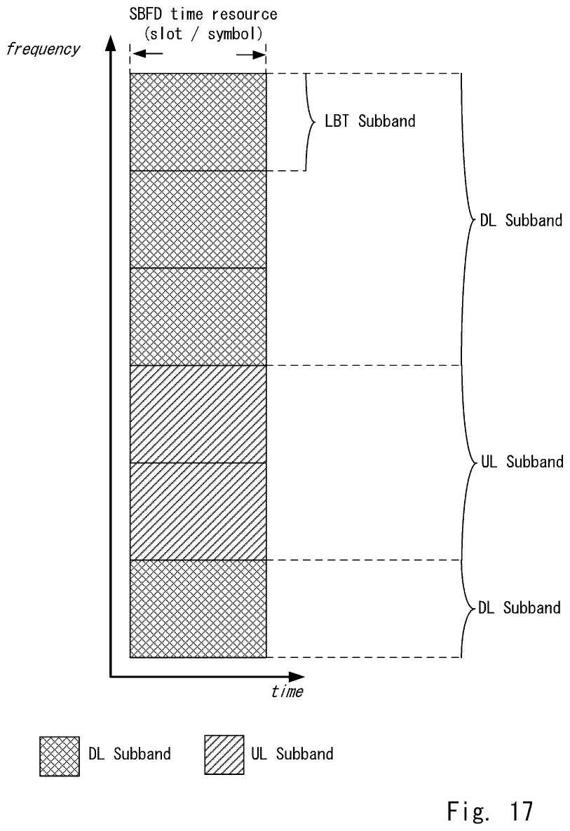

FIG. 17 is a simplified time frequency diagram illustrating another example of how SBFD may be implemented in the communication system 1. In this example the LBT bandwidth comprises a number of discrete LBT subbands each comprising a respective set of contiguous resource blocks (i.e., an ‘RB set’). The UL and DL subbands for SBFD are configured to ensure that each LBT subband/RB set may include, all or part of a DL subband, or all or part of a UL subband, but does not include both resources of a DL subband and resources of a UL subband. Accordingly, each DL subband and each UL subband can comprise one or more RB sets in which LBT may be performed for channel access.

Specifically, assuming that there are an integer number ‘N’ of RB sets configured for a cell 9 by the base station 5 to the UE 3, where each RB set is defined by start PRB and end PRB (or start PRB and number of contiguous PRBs in the RB set), the base station 5 is able to configure a (sub) set of ‘N1’ RB sets for an UL subband (where N1 is an integer less than N). It will be understood that the N1 RB sets can be consecutive in frequency domain (i.e., adjacent in frequency domain) to align with the typical SBFD framework (as currently proposed) comprising a (typically) single continuous UL subband within a cell bandwidth. The remaining RB sets (i.e., N-N1) can then be treated as being applicable for the frequency allocation of one or more DL subbands. In another example, for each of the DL and UL subbands, the base station 5 may simply configure a set of contiguous RB sets as part of a frequency allocation assignment.

It will be appreciated that these examples could be adapted to a scenario in which there is a single continuous DL subband and one or more UL subbands (i.e., where the references to ‘UL’ and ‘DL’ above are reversed). The resource allocation for uplink transmission in an SBFD slot/symbol may be determined, by the UE, to be an intersection between a UL interlace allocation (i.e., resources that form part of both one or more UL interlaces and the UL subband), and the frequency allocation for the UL subband.

It will be appreciated that there are different ways in which the mapping between one or more DL subbands/one or more UL subbands and the LBT subbands/RB sets may be implemented. For example, in one implementation each DL/UL subband may be associated with more than one LBT subband (as seen in FIG. 17). However, in another implementation, each DL/UL subband may be respectively associated with only a single LBT subband albeit that this would mean that more than one UL subband may exist for a single cell which is not supported in current SBFD implementations.

It will be appreciated that, while not shown, a guard band may be configured between the RB sets (LBT subbands). For example, a guard band may be configured based on the existing 3GPP methodology for “intra-cell guard bands”. Nevertheless, beneficially, different guard band values may be configurable for SBFD and non-SBFD symbols.

### LBT for SBFD Based on LBT Subbands

As mentioned above, in the scenario in which each LBT subband is respectively mapped to an UL subband, or to an DL subband, a number of different LBT techniques may be used to allow the base station 5 and UE 3 to access a channel on the unlicensed spectrum.

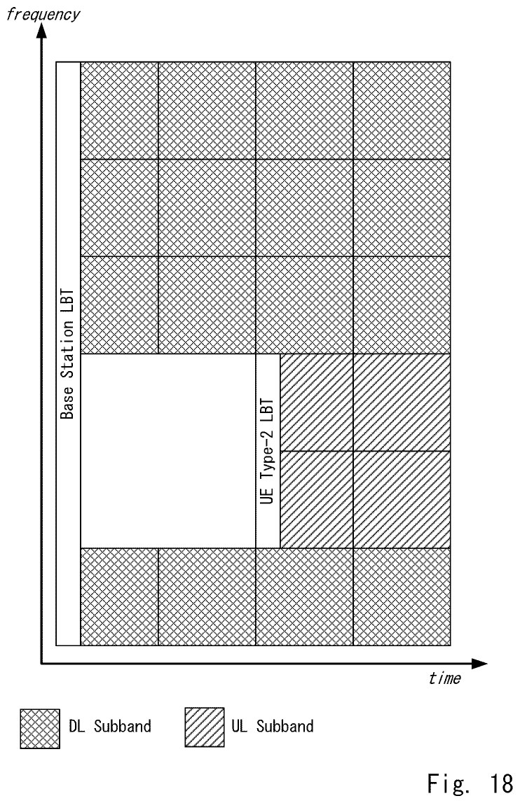

FIG. 18 is a simplified time frequency diagram illustrating one LBT technique that may be used, in the context of SBFD based on LBT subbands, in the communication system.

In this example, the base station 5 is configured to perform LBT for all of the LBT subbands (including one or more LBT subbands associated with a UL subband). When LBT is successful, the base station 5 indicates the acquired COT to the UE 3, which can then perform Type-2 LBT to access and share the COT. It will be appreciated that, in this example, the base station 5 may directly share the COT to the UE 3, without needing to perform any initial DL transmission within the UL subband region. Nevertheless, the base station may be allowed to share the COT to the UE 3 only after performing an initial DL transmission. In this case, the initial DL transmission may be performed either at the start of the SBFD slot/symbol, or before the start of the SBFD slot/symbol.

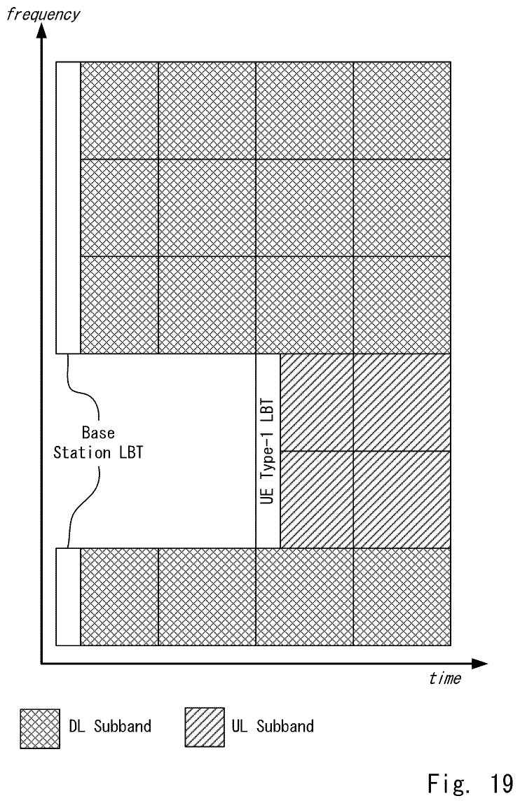

FIG. 19 is a simplified time frequency diagram illustrating another LBT technique that may be used, in the context of SBFD based on LBT subbands, in the communication system.

In this example, the base station 5 performs LBT for only the LBT subbands associated with one or more DL subbands of the SBFD configuration. The base station 5, in this case, send an indication (e.g., of the acquired COT duration) to the UE 3 to trigger the UE 3 to perform Type-1 LBT for one or more LBT subbands associated with one or more UL subbands of the SBFD configuration. When indicating the COT duration to the UE 3, the base station 5 may provide information indicating the applicability of the shared COT. This information may, for example, indicate that the COT is applicable for: one or more LBT subbands; for one or more DL subbands only or for both the UL and DL subband; and/or one or more specific frequency regions for which the COT is applicable.

### Contiguous SBFD UL and DL Subbands in Unlicensed Spectrum

As mentioned above, in another beneficial method, the base station 5 is able to configure the UE 3 with both the DL and the UL subbands for SBFD operation, within the same LBT bandwidth, in a similar manner to the way in which they would be configured for operation in licensed spectrum.

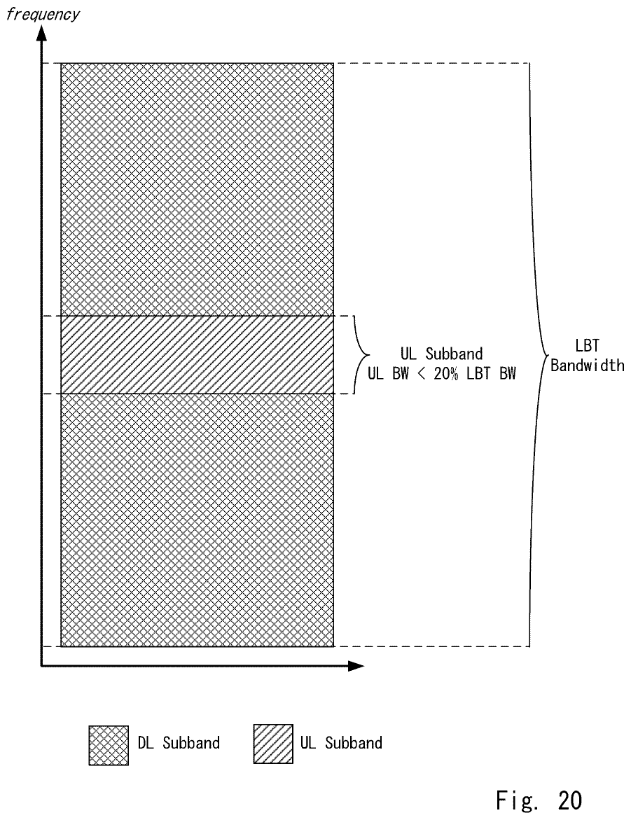

This method will now be described in more detail with reference to FIG. 20, which is a simplified time frequency diagram illustrating another example of how SBFD may be implemented in the communication system 1.

As seen in FIG. 20, in this example, the SBFD UL and DL subbands each occupy contiguous frequency resources forming part of the same LBT bandwidth.

Nevertheless, SBFD operation is only allowed to be used in the unlicensed channel subject to one or more of the following conditions:
A condition that the total bandwidth of UL subband, within an LBT bandwidth, occupies no more than a maximum proportion (e.g., 20%) of the LBT bandwidth, and/or that UL transmission within an SBFD symbol must always be accompanied by a DL transmission, from the base station 5, which occupies a minimum proportion (e.g., 80%) of the LBT bandwidth;
To allow for such a low UL bandwidth, a restriction may be placed on which channels may be used for UL transmission in an SBFD slot/symbol. For example, only selected UL physical channels (e.g. PUCCH, PRACH) may be configured/allowed during SBFD symbols/slots;
A condition that there is no other communicating node/technology present in the vicinity of the base station 5 and/or UE 3 involved in the SBFD communication. To facilitate this the presence of communicating node can be inferred from a dynamic frequency selection (DFS) mechanism (e.g., in which channel sensing is used to measure energy on the LBT channel and determine if that energy is less than a threshold value);
A condition that a measured or estimated distance between the UE 3 and base station 5 is less than a minimum threshold. The distance may be estimated, for example, based on the strength of a signal strength (e.g., RSRP) measured at the UE 3 for a signal (e.g., a reference signal) received from the base station;
A condition that a communication beam used by the base station 5 and/or UE 3 has an azimuthal and/or altitude beam width for communication greater than a threshold value or that an omnidirectional beam is used for communication. This condition might be beneficial, for example, use of a higher beam width or omnidirectional antenna (e.g., by a base station) allows for a nearby node that is listening for channel interference to sense interference in both the UL and DL subband (and thereby an entire LBT bandwidth). Contrastingly, for a small beam width there is a risk that a nearby node might observe interference only in a single (e.g., UL) subband which makes it hard to sense and can hence reduce system performance;
A condition that a semi-static channel occupancy mode, or frame-based equipment (FBE) mode, is used at the UE 3 for channel access. In a semi-static channel occupancy/FBE mode, a base station 5 is able to perform channel sensing with a given periodicity (Tₓ). Channel sensing is typically performed for a very small duration (Tₛ₁<<Tₓ). If a channel is sensed to be idle then the base station can use the remaining part of the period (Tₓ) duration for communication with the UE 3.

It will be appreciated that LBT for this method may be performed in a similar manner to that described with reference to FIG. 15 or FIG. 16.

### Channel Access Based on Symbol Type

As mentioned above, in another beneficial method, the base station 5 and UE 3 are configured to use a type of channel access procedure and/or one or more channel access parameters that are dependent on the slot/symbol type.

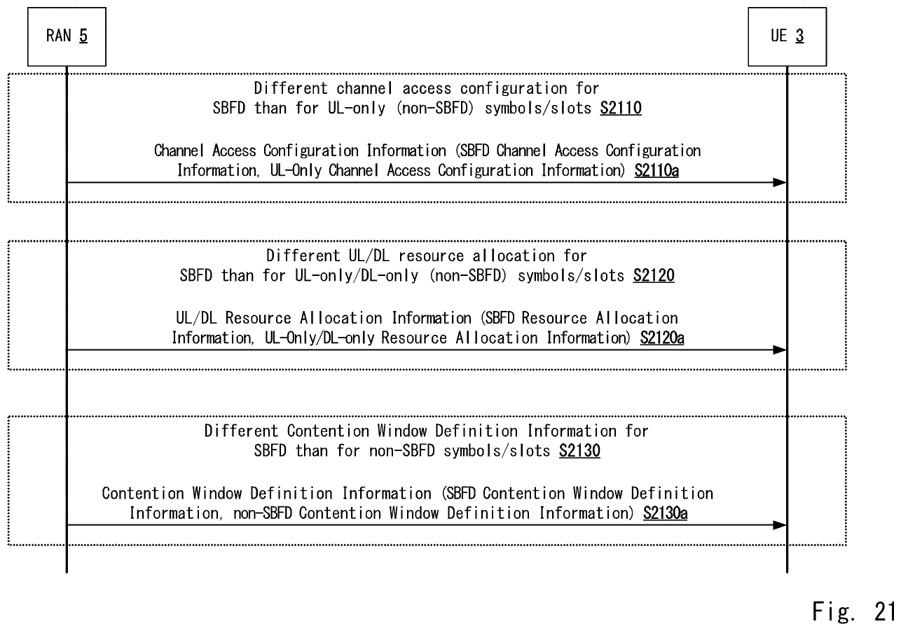

FIG. 21 is a simplified sequence diagram illustrating a number of different ways in which channel access parameters may be configured in the communication system 1. It will be appreciated that the different options shown in FIG. 21 are neither mutually exclusive from nor mutually dependent on one another.

In each of the examples shown in FIG. 21 different channel access parameters are configured/indicated to UE 3 for SBFD slots/symbols than for at least some other (non-SBFD) slot/symbols (e.g., slots/symbols (e.g., UL-only slots/symbols, DL-only slots/symbols, or all non-SBFD slots/symbols).

In one example, illustrated at S2110, separate channel access configurations are provided to the UE 3 corresponding to SBFD slots/symbols and corresponding to UL-only (non-SBFD) symbols.

Specifically, as seen at S2110a, the base station 5 transmits different information for defining a channel access configuration for SBFD symbols/slots than information for defining a channel access configuration for UL-only (non-SBFD) symbols/slots. It will be appreciated that while, for simplicity, the different channel access channel access configuration information for the different slot/symbol types is shown being transmitted in the same message the different channel access channel access configuration information may be transmitted in different messages (and/or different types of message). Moreover, the channel access configuration information for a particular type of slot/symbol may be provided in a plurality of different messages defining different parts of the configuration. The channel access configuration information for a particular type of slot/symbol may also define the configuration (or part of the configuration) relative to, or by reference to, previously provided configuration information for that type of slot/symbol or for a different type of slot/symbol.

Providing different channel access configurations for SBFD slots/symbols than for UL-only symbols is particularly beneficial in for configured UL resources for accessing the channel (e.g., configured grant, resources for a PUCCH, resources for SRS and/or the like). Nevertheless, the provision of different channel access configurations for SBFD slots/symbols than for UL-only symbols may also be beneficial for dynamic transmissions as well. For example, in the case of a set of PUSCH repetitions, the base station 5 may provide different channel access parameters for different repetitions depending on whether the repeated transmission will occur within an SBFD slot/symbol or within a UL-only slot/symbol.

In another example, illustrated at S2120, the configuration of the UL/DL resource allocation (e.g., the interlace based configuration) may be different for SBFD symbols/slots than for UL-only or DL-only (non-SBFD) symbols/slots.

Specifically, as seen at S2120a, the base station 5 transmits different UL/DL resource allocation information for defining the resources to be used in the UL and the DL for SBFD symbols/slots than for UL-only (non-SBFD) symbols/slots. It will be appreciated that while, for simplicity, the different UL/DL resource allocation information for the different slot/symbol types is shown being transmitted in the same message the different UL/DL resource allocation information may be transmitted in different messages (and/or different types of message). Moreover, the UL/DL resource allocation information for a particular type of slot/symbol may be provided in a plurality of different messages defining different parts of the allocation. The UL/DL resource allocation information for a particular type of slot/symbol may also define the allocation (or part of the allocation) relative to, or by reference to, a previously provided allocation for that type of slot/symbol or for a different type of slot/symbol.

For example, the base station 5 may indicate that DL channels shall use an interlace based resource allocation for SBFD symbols but a non-interlaced resource allocation for non-SBFD symbols. In another example, a configuration of one or more UL interlaces (e.g., available interlaces and/or interlace frequency resources) may be different for SBFD slots/symbols than for UL-only (non-SBFD) slots/symbols.

In another example, illustrated at S2130, the contention window adjustment procedure is defined differently for SBFD slots/symbols than for non-SBFD slots/symbols.

Specifically, as seen at S2130a, the base station 5 transmits different information for configuring the contention window to be used for SBFD symbols/slots than for UL-only (non-SBFD) symbols/slots. It will be appreciated that while, for simplicity, the different contention window configuration information for the different slot/symbol types is shown being transmitted in the same message the different contention window configuration information may be transmitted in different messages (and/or different types of message). Moreover, the contention window configuration information for a particular type of slot/symbol may be provided in a plurality of different messages defining different parts of the configuration. The contention window configuration information for a particular type of slot/symbol may also define the allocation (or part of the configuration) relative to, or by reference to, a previously provided configuration for that type of slot/symbol or for a different type of slot/symbol.

For example, the contention window configuration information may define a contention window size timer differently for SBFD slots/symbols than for non-SBFD slots/symbols.

It will, nevertheless, be appreciated that, alternatively or additionally, the UE 3 may be configured to adjust the contention window independently, for the different slot/symbol types, without necessarily requiring different configuration information from the base station.

### User Equipment

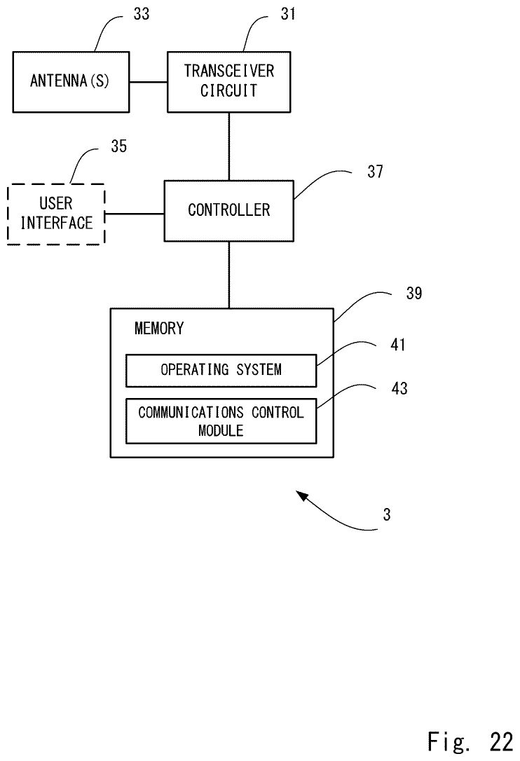

FIG. 22 is a schematic block diagram illustrating the main components of a UE 3 as shown in FIG. 5.

As shown, the UE 3 has a transceiver circuit 31 that is operable to transmit signals to and to receive signals from a base station 5 via one or more antenna 33 (e.g., comprising one or more antenna elements). The UE 3 has a controller 37 to control the operation of the UE 3. The controller 37 is associated with a memory 39 and is coupled to the transceiver circuit 31. Although not necessarily required for its operation, the UE 3 might, of course, have all the usual functionality of a conventional UE 3 (e.g. a user interface 35, such as a touch screen/keypad/microphone/speaker and/or the like for, allowing direct control by and interaction with a user) and this may be provided by any one or any combination of hardware, software, and firmware, as appropriate. Software may be pre-installed in the memory 39 and/or may be downloaded via the communication system 1 or from a removable data storage device (RMD), for example.

The controller 37 is configured to control overall operation of the UE 3 by, in this example, program instructions or software instructions stored within memory 39.

As shown, these software instructions include, among other things, an operating system 41, and a communications control module 43.

The communications control module 43 is operable to control the communication between the UE 3 and its one or more serving base stations 5 (and other communication devices connected to the base station 5, such as further UEs and/or core network nodes). The communications control module 43 is configured for the overall handling uplink communications via associated uplink channels (e.g., via a physical uplink control channel (PUCCH), random access channel (RACH), and/or a physical uplink shared channel (PUSCH)) including both dynamic and semi-static signalling (e.g., SRS). The communications control module 43 is also configured for the overall handling of receipt of downlink communications via associated downlink channels (e.g., via a physical downlink control channel (PDCCH) and/or a physical downlink shared channel (PDSCH)) including both dynamic and semi-static signalling (e.g., CSI-RS). The communications control module 43 is responsible, for example: for determining where to monitor for downlink control information (e.g., the location of CSSs/USSs, CORESETs, and associated PDCCH candidates to monitor); for determining the resources to be used by the UE 3 for transmission/reception of UL/DL communications (including interleaved resources and resources subject to frequency hopping); for managing frequency hopping at the UE side; for determining how slots/symbols are configured (e.g., for UL, DL or SBFD communication, or the like); for determining which one or more bandwidth parts are configured for the UE 3; for determining how uplink transmissions should be encoded; for applying any SBFD specific communication configurations appropriately; for performing channel access (e.g., LBT) procedures for accessing unlicensed spectrum; and the like.

### Base Station

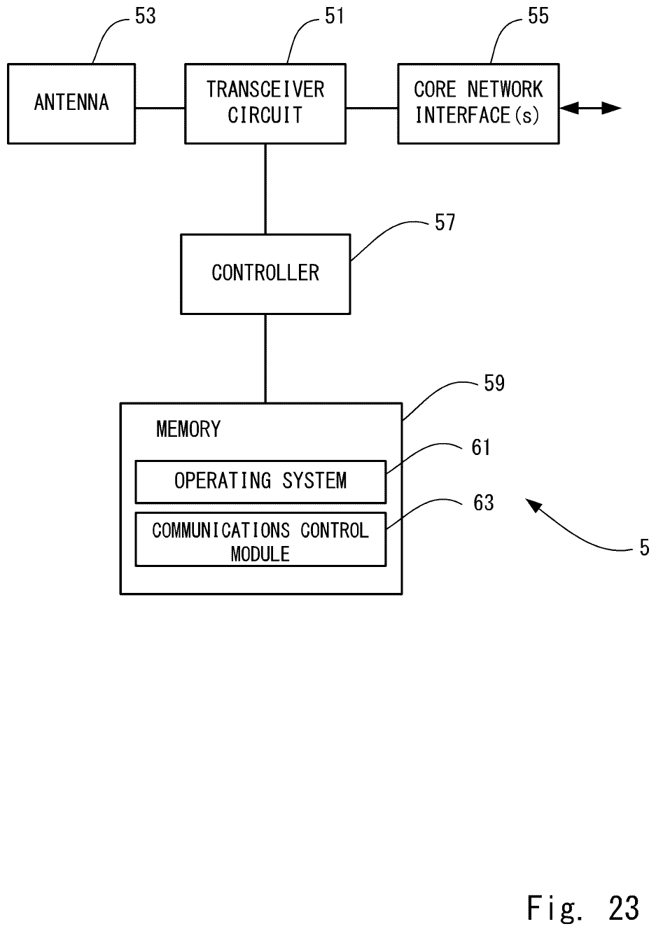

FIG. 23 is a schematic block diagram illustrating the main components of the base station 5 for the communication system 1 shown in FIG. 5. As shown, the base station 5 has a transceiver circuit 51 for transmitting signals to and for receiving signals from the communication devices (such as UEs 3) via one or more antenna 53 (e.g. a single or multi-panel antenna array/massive antenna), and a core network interface 55 (e.g. comprising the N2, N3 and other reference points/interfaces) for transmitting signals to and for receiving signals from network nodes in the core network 7. Although not shown, the base station 5 may also be coupled to other base stations via an appropriate interface (e.g. the so-called ‘Xn’ interface in NR). The base station 5 has a controller 57 to control the operation of the base station 5. The controller 57 is associated with a memory 59. Software may be pre-installed in the memory 59 and/or may be downloaded via the communication system 1 or from a removable data storage device (RMD), for example. The controller 57 is configured to control the overall operation of the base station 5 by, in this example, program instructions or software instructions stored within memory 59.

As shown, these software instructions include, among other things, an operating system 61 and a communications control module 63.

The communications control module 63 is operable to control the communication between the base station 5 and UEs 3 and other network entities that are connected to the base station 5. The communications control module 63 is configured for the overall control of the reception and decoding of uplink communications, via associated uplink channels (e.g. via a physical uplink control channel (PUCCH), a random-access channel (RACH), and/or a physical uplink shared channel (PUSCH)) including both dynamic and semi-static signalling (e.g., SRS). The communications control module 63 is also configured for the overall handling the transmission of downlink communications via associated downlink channels (e.g. via a physical downlink control channel (PDCCH) and/or a physical downlink shared channel (PDSCH)) including both dynamic and semi-static signalling (e.g., CSI-RS). The communications control module 63 is responsible for managing full duplex (e.g., SBFD) communication including, where appropriate, the segregation of UL and DL communication via different physical antenna elements. The communications control module 63 is responsible, for example: for determining where to configure the UE 3 to monitor for downlink control information (e.g., the location of CSSs/USSs, CORESETs, and associated PDCCH candidates to monitor); for determining the resources to be scheduled for UE transmission/reception of UL/DL communications (including interleaved resources and resources subject to frequency hopping); for managing frequency hopping at the base station side; for configuring slots/symbols appropriately (e.g., for UL, DL or SBFD communication, or the like); for configuring one or more bandwidth parts for the UE 3; for performing channel access (e.g., LBT) procedures for accessing unlicensed spectrum and/or for communicating with the UE 3 to configure/trigger LBT at the UE; for providing related configuration signalling to the UE 3; and the like.

### Modifications and Alternatives

A detailed example embodiment has been described above. As those skilled in the art will appreciate, a number of modifications and alternatives can be made to the above example embodiments whilst still benefiting from the disclosure embodied therein.

It will be appreciated, for example, that whilst cellular communication generation (2G, 3G, 4G, 5G, 6G etc.) specific terminology may be used, in the interests of clarity, to refer to specific communication entities, the technical features described for a given entity are not limited to devices of that specific communication generation. The technical features may be implemented in any functionally equivalent communication entity regardless of any differences in the terminology used to refer to them.

In the above description, the UEs and the base station are described for ease of understanding as having a number of discrete functional components or modules. Whilst these modules may be provided in this way for certain applications, for example where an existing system has been modified to implement the disclosure, in other applications, for example in systems designed with the inventive features in mind from the outset, these modules may be built into the overall operating system or code and so these modules may not be discernible as discrete entities.

In the above example embodiments, a number of software modules were described. As those skilled in the art will appreciate, the software modules may be provided in compiled or un-compiled form and may be supplied to the base station, to the mobility management entity, or to the UE as a signal over a computer network, or on a recording medium. Further, the functionality performed by part, or all of this software may be performed using one or more dedicated hardware circuits. However, the use of software modules is preferred as it facilitates the updating of the base station or the UE in order to update their functionalities.

Each controller may comprise any suitable form of processing circuitry including (but not limited to), for example: one or more hardware implemented computer processors; microprocessors; central processing units (CPUs); arithmetic logic units (ALUs); input/output (IO) circuits; internal memories/caches (program and/or data); processing registers; communication buses (e.g. control, data and/or address buses); direct memory access (DMA) functions; hardware or software implemented counters, pointers and/or timers; and/or the like. Various other modifications will be apparent to those skilled in the art and will not be described in further detail here.

The base station may comprise a ‘distributed’ base station having a central unit ‘CU’ and one or more separate distributed units (DUs).

The User Equipment (or “UE”, “mobile station”, “mobile device” or “wireless device”) in the present disclosure is an entity connected to a network via a wireless interface.

It should be noted that the present disclosure is not limited to a dedicated communication device and can be applied to any device having a communication function as explained in the following paragraphs.

The terms “User Equipment” or “UE” (as the term is used by 3GPP), “mobile station”, “mobile device”, and “wireless device” are generally intended to be synonymous with one another, and include standalone mobile stations, such as terminals, cell phones, smart phones, tablets, cellular IoT devices, IoT devices, and machinery. It will be appreciated that the terms “mobile station” and “mobile device” also encompass devices that remain stationary for a long period of time.

A UE may, for example, be an item of equipment for production or manufacture and/or an item of energy related machinery (for example equipment or machinery such as: boilers; engines; turbines; solar panels; wind turbines; hydroelectric generators; thermal power generators; nuclear electricity generators; batteries; nuclear systems and/or associated equipment; heavy electrical machinery; pumps including vacuum pumps; compressors; fans; blowers; oil hydraulic equipment; pneumatic equipment; metal working machinery; manipulators; robots and/or their application systems; tools; molds or dies; rolls; conveying equipment; elevating equipment; materials handling equipment; textile machinery; sewing machines; printing and/or related machinery; paper converting machinery; chemical machinery; mining and/or construction machinery and/or related equipment; machinery and/or implements for agriculture, forestry and/or fisheries; safety and/or environment preservation equipment; tractors; precision bearings; chains; gears; power transmission equipment; lubricating equipment; valves; pipe fittings; and/or application systems for any of the previously mentioned equipment or machinery etc.).

A UE may, for example, be an item of transport equipment (for example transport equipment such as: rolling stocks; motor vehicles; motorcycles; bicycles; trains; buses; carts; rickshaws; ships and other watercraft; aircraft; rockets; satellites; drones; balloons etc.).

A UE may, for example, be an item of information and communication equipment (for example information and communication equipment such as: electronic computer and related equipment; communication and related equipment; electronic components etc.).

A UE may, for example, be a refrigerating machine, a refrigerating machine applied product, an item of trade and/or service industry equipment, a vending machine, an automatic service machine, an office machine or equipment, a consumer electronic and electronic appliance (for example a consumer electronic appliance such as: audio equipment; video equipment; a loud speaker; a radio; a television; a microwave oven; a rice cooker; a coffee machine; a dishwasher; a washing machine; a dryer; an electronic fan or related appliance; a cleaner etc.). A UE may, for example, be an electrical application system or equipment (for example an electrical application system or equipment such as: an x-ray system; a particle accelerator; radio isotope equipment; sonic equipment; electromagnetic application equipment; electronic power application equipment etc.).

A UE may, for example, be an electronic lamp, a luminaire, a measuring instrument, an analyzer, a tester, or a surveying or sensing instrument (for example a surveying or sensing instrument such as: a smoke alarm; a human alarm sensor; a motion sensor; a wireless tag etc.), a watch or clock, a laboratory instrument, optical apparatus, medical equipment and/or system, a weapon, an item of cutlery, a hand tool, or the like.

A UE may, for example, be a wireless-equipped personal digital assistant or related equipment (such as a wireless card or module designed for attachment to or for insertion into another electronic device (for example a personal computer, electrical measuring machine)).

A UE may be a device or a part of a system that provides applications, services, and solutions described below, as to “internet of things (IoT)”, using a variety of wired and/or wireless communication technologies.

Internet of Things devices (or “things”) may be equipped with appropriate electronics, software, sensors, network connectivity, and/or the like, which enable these devices to collect and exchange data with each other and with other communication devices. IoT devices may comprise automated equipment that follow software instructions stored in an internal memory. IoT devices may operate without requiring human supervision or interaction. IoT devices might also remain stationary and/or inactive for a long period of time. IoT devices may be implemented as a part of a (generally) stationary apparatus. IoT devices may also be embedded in non-stationary apparatus (e.g. vehicles) or attached to animals or persons to be monitored/tracked.

It will be appreciated that IoT technology can be implemented on any communication devices that can connect to a communications network for sending/receiving data, regardless of whether such communication devices are controlled by human input or software instructions stored in memory.

It will be appreciated that IoT devices are sometimes also referred to as Machine-Type Communication (MTC) devices or Machine-to-Machine (M2M) communication devices. It will be appreciated that a UE may support one or more IoT or MTC applications. Some examples of MTC applications are listed in the following table 3. This list is not exhaustive and is intended to be indicative of some examples of machine-type communication applications.

TABLE 3

| Service Area | MTC applications |
|---|---|
| Security | Surveillance systems |
| | Backup for landline |
| | Control of physical access (e.g. to buildings) |
| | Car/driver security |
| Tracking & Tracing | Fleet Management |
| | Order Management |
| | Pay as you drive |
| | Asset Tracking |
| | Navigation |
| | Traffic information |
| | Road tolling |
| | Road traffic optimisation/steering |
| Payment | Point of sales |
| | Vending machines |
| | Gaming machines |
| Health | Monitoring vital signs |
| | Supporting the aged or handicapped |
| | Web Access Telemedicine points |
| | Remote diagnostics |
| Remote Maintenance/ | Sensors |
| Control | Lighting |
| | Pumps |
| | Valves |
| | Elevator control |
| | Vending machine control |
| | Vehicle diagnostics |
| Metering | Power |
| | Gas |
| | Water |
| | Heating |
| | Grid control |
| | Industrial metering |
| Consumer Devices | Digital photo frame |
| | Digital camera |
| | eBook |

Applications, services, and solutions may be an MVNO (Mobile Virtual Network Operator) service, an emergency radio communication system, a PBX (Private Branch exchange) system, a PHS/Digital Cordless Telecommunications system, a POS (Point of sale) system, an advertise calling system, an MBMS (Multimedia Broadcast and Multicast Service), a V2X (Vehicle to Everything) system, a train radio system, a location related service, a Disaster/Emergency Wireless Communication Service, a community service, a video streaming service, a femto cell application service, a VoLTE (Voice over LTE) service, a charging service, a radio on demand service, a roaming service, an activity monitoring service, a telecom carrier/communication NW selection service, a functional restriction service, a PoC (Proof of Concept) service, a personal information management service, an ad-hoc network/DTN (Delay Tolerant Networking) service, etc.

Further, the above-described UE categories are merely examples of applications of the technical ideas and example embodiments described in the present document. Needless to say, these technical ideas and example embodiments are not limited to the above-described UE and various modifications can be made thereto.

Various other modifications will be apparent to those skilled in the art and will not be described in further detail here.

Each of the drawings or figures is merely an example to illustrate one or more example embodiments. Each figure may not be associated with only one particular example embodiment, but may be associated with one or more other example embodiments. As those of ordinary skill in the art will understand, various features or steps described with reference to any one of the figures can be combined with features or steps illustrated in one or more other figures, for example, to produce example embodiments that are not explicitly illustrated or described. Not all of the features or steps illustrated in any one of the figures to describe an example embodiment are necessarily essential, and some features or steps may be omitted. The order of the steps described in any of the figures may be changed as appropriate.

The whole or part of the example embodiments disclosed above can be described as, but not limited to, the following supplementary notes.

### (Supplementary Note 1)

A method performed by a user equipment (UE), the method comprising:
receiving, from an access network node, configuration information for configuring frequency resources in at least one time resource for subband full duplex (SBFD) to meet an occupied bandwidth requirement of a Listen-Before-Talk (LBT) bandwidth, and
configuring the frequency resources based on the configuration information.

### (Supplementary Note 2)

The method according to supplementary note 1, wherein
each of at least one downlink subband of the frequency resources and at least one uplink subband of the frequency resources is distributed throughout the LBT bandwidth.

### (Supplementary Note 3)

The method according to supplementary note 2, wherein
frequency resources for the at least one downlink subband and frequency resources for the at least one uplink subband are interlacedly allocated.

### (Supplementary Note 4)

The method according to supplementary note 3, further comprising:
determining an unused set of frequency resources to remain unused for uplink or downlink communication in the LBT bandwidth.

### (Supplementary Note 5)

The method according to supplementary note 4, further comprising:
receiving, from the access network node, further configuration information for configuring the unused set of the frequency resources, and
wherein the determining is performed by determining based on the further configuration information.

### (Supplementary Note 6)

The method according to supplementary note 4, wherein
the determining is performed by determining based on the frequency resources for the at least one downlink subband and the frequency resources for the at least one uplink subband.

### (Supplementary Note 7)

The method according to any one of supplementary notes 3 to 6, further comprising:
receiving downlink transmission that is rate matched around frequency resources that do not belong to the frequency resources for the at least one downlink subband.

### (Supplementary Note 8)

The method according to any one of supplementary notes 3 to 6, further comprising:
receiving downlink transmission that is rate matched around the frequency resources for the at least one uplink subband.

### (Supplementary Note 9)

The method according to any one of supplementary notes 3 to 6, wherein
the configuration information includes information for indicating at least one downlink interlace within the frequency resources for the at least one downlink subband, and the method comprising:
receiving downlink transmission using the at least one downlink interlace.

### (Supplementary Note 10)

The method according to any one of supplementary notes 3 to 9, wherein
the configuration information includes information for indicating at least one uplink interlace within the frequency resources for the at least one uplink subband, and the method comprising:
transmitting uplink transmission using the at least one uplink interlace.

### (Supplementary Note 11)

The method according to any one of supplementary notes 3 to 10, further comprising:
transmitting uplink transmission without performing LBT while downlink transmission is continuously performed at the time when the uplink transmission is expected to start, wherein
the transmitting the uplink transmission without performing the LBT is restricted to at least one of:
a specific number of uplink transmissions within a channel occupancy time acquired by the access network node,
uplink transmission whose uplink transmission period is less than a specific threshold,
UEs associated with a beam that is used by the access network node to perform the LBT and/or to perform downlink transmission, or
a case where the LBT is of a type-1 channel access procedure with a priority associated with a longest contention window period.

### (Supplementary Note 12)

The method according to any one of supplementary notes 3 to 10, further comprising:
determining a period during which downlink transmissions are temporarily stopped;
temporarily stopping the downlink transmissions before performing LBT; and
performing the LBT in the period during which the downlink transmissions is temporarily stopped.

### (Supplementary Note 13)

The method according to supplementary note 12, wherein
the period is configured to occur in at least one specific time resource.

### (Supplementary Note 14)

The method according to supplementary note 13, wherein
the at least one specific time resource includes a symbol at a start of a slot and/or a 7th symbol of a slot or subframe.

### (Supplementary Note 15)

The method according to any one of supplementary notes 12 to 14, wherein
the period is configured to occur at least one of:
between two downlink transmissions, or
during an ongoing downlink transmission, and the method further comprising:
rate matching the downlink transmissions based on the period.

### (Supplementary Note 16)

The method according to any one of supplementary notes 12 to 15, wherein
the period is configured to be no greater than a maximum gap required for a Type-2 channel access procedure.

### (Supplementary Note 17)

The method according to supplementary note 1, wherein
the LBT bandwidth includes either a downlink subband of the frequency resources or an uplink subband of the frequency resources.

### (Supplementary Note 18)

The method according to supplementary note 17, further comprising:
receiving information for indicating at least one uplink interlace; and
transmitting uplink transmissions using resources corresponding to an intersection between the at least one uplink interlace and frequency resources for the at least one uplink subband.

### (Supplementary Note 19)

The method according to supplementary note 17 or 18, wherein
each of the downlink subband of the frequency resources and the uplink subband of the frequency resources corresponds to one or more of LBT bandwidths.

### (Supplementary Note 20)

The method according to any one of supplementary notes 17 to 19, further comprising:

receiving information for indicating that the access network node has acquired a channel occupancy time for both the downlink subband of the frequency resources and the uplink subband of the frequency resources; and
performing a type-2 channel access procedure for uplink transmissions during the channel occupancy time based on the information.

### (Supplementary Note 21)

The method according to supplementary note 20, wherein
the receiving the information is performed without a prior downlink transmission, by the access network node, in frequency resources for the uplink subband of the frequency resources.

### (Supplementary Note 22)

The method according to supplementary note 20, wherein
the receiving the information is performed after a prior downlink transmission, by the access network node, in frequency resources for the uplink subband of the frequency resources.

### (Supplementary Note 23)

The method according to supplementary note 22, wherein
the prior downlink transmission is performed at a start of at least one time resource for the SBFD, or before the start of the at least one time resource for the SBFD.

### (Supplementary Note 24)

The method according to any one of supplementary notes 17 to 19, further comprising:
receiving information for indicating that the access network node has acquired a channel occupancy time for the downlink subband of the frequency resources; and
performing a type-1 channel access procedure for uplink transmissions during the channel occupancy time based on the information.

### (Supplementary Note 25)

The method according to supplementary note 24, wherein
the information for indicating that the access network node has acquired a channel occupancy time for the downlink subband of the frequency resources indicates at least one of:
which LBT bandwidth that the channel occupancy time is applicable for,
the downlink subband or both the uplink subband and the downlink subband that that the channel occupancy time is applicable for, or
frequency resources for which the channel occupancy time is applicable.

### (Supplementary Note 26)

The method according to supplementary note 1, wherein
total bandwidth of uplink subband within the LBT bandwidth occupies less than a first proportion of the LBT bandwidth and uplink transmission within the at least one time resource for the SBFD is accompanied with a downlink transmission from the access network node which occupies at least a second proportion of the LBT bandwidth.

### (Supplementary Note 27)

A method performed by a user equipment (UE), the method comprising:
performing a subband full duplex (SBFD) operation in a case where at least one of following conditions is met:
a condition that total bandwidth of uplink subband within a Listen-Before-Talk (LBT) bandwidth occupies less than a first proportion of the LBT bandwidth and uplink transmission within at least one time resource for the SBFD is accompanied with a downlink transmission from an access network node which occupies at least a second proportion of the LBT bandwidth,
a condition that no other communicating node is detected as being present in a vicinity of the access network node and/or the UE;
a condition that a distance between the UE and the access network node is less than a threshold;
a condition that a beam used by the access network node and/or the UE has a beam width in at least one dimension that is greater than a threshold, or is an omnidirectional beam; or
a condition that a semi-static channel occupancy mode, or frame-based equipment (FBE) mode, is used.

### (Supplementary Note 28)

The method according to any one of supplementary notes 1 to 27, wherein
the configuration information includes further configuration information for configuring frequency resources in at least one time resource for non-SBFD.

### (Supplementary Note 29)

The method according to supplementary note 28, wherein
the configuration information includes at least one of:
information for channel access configuration,
information for resource allocation, or
information for contention window adjustment procedure,
which are defined differently for the at least one time resource for the SBFD and for the at least one time resource for the non-SBFD.

### (Supplementary Note 30)

A method performed by an access network node, the method comprising:
transmitting, to a user equipment (UE), configuration information for configuring frequency resources in at least one time resource for subband full duplex (SBFD) to meet an occupied bandwidth requirement of a Listen-Before-Talk (LBT) bandwidth, wherein
the configuration information causes the UE to configure the frequency resources.

### (Supplementary Note 31)

A method performed by an access network node, the method comprising:
performing a subband full duplex (SBFD) operation in a case where at least one of following conditions is met:
a condition that total bandwidth of uplink subband within a Listen-Before-Talk (LBT) bandwidth occupies less than a first proportion of the LBT bandwidth and uplink transmission within at least one time resource for the SBFD is accompanied with a downlink transmission from the access network node which occupies at least a second proportion of the LBT bandwidth,
a condition that no other communicating node is detected as being present in a vicinity of the access network node and/or a user equipment (UE);
a condition that a distance between the UE and the access network node is less than a threshold;
a condition that a beam used by the access network node and/or the UE has a beam width in at least one dimension that is greater than a threshold, or is an omnidirectional beam; or
a condition that a semi-static channel occupancy mode, or frame-based equipment (FBE) mode, is used.

### (Supplementary Note 32)

A user equipment (UE) comprising:
means for receiving, from an access network node, configuration information for configuring frequency resources in at least one time resource for subband full duplex (SBFD) to meet an occupied bandwidth requirement of a Listen-Before-Talk (LBT) bandwidth, and
means for configuring the frequency resources based on the configuration information.

### (Supplementary Note 33)

A user equipment (UE) comprising:
means for performing a subband full duplex (SBFD) operation in a case where at least one of following conditions is met:
a condition that total bandwidth of uplink subband within a Listen-Before-Talk (LBT) bandwidth occupies less than a first proportion of the LBT bandwidth and uplink transmission within at least one time resource for the SBFD is accompanied with a downlink transmission from an access network node which occupies at least a second proportion of the LBT bandwidth,
a condition that no other communicating node is detected as being present in a vicinity of the access network node and/or the UE;
a condition that a distance between the UE and the access network node is less than a threshold;
a condition that a beam used by the access network node and/or the UE has a beam width in at least one dimension that is greater than a threshold, or is an omnidirectional beam; or
a condition that a semi-static channel occupancy mode, or frame-based equipment (FBE) mode, is used.

### (Supplementary Note 34)

An access network node comprising:
means for transmitting, to a user equipment (UE), configuration information for configuring frequency resources in at least one time resource for subband full duplex (SBFD) to meet an occupied bandwidth requirement of a Listen-Before-Talk (LBT) bandwidth, wherein
the configuration information causes the UE to configure the frequency resources.

### (Supplementary Note 35)

An access network node comprising:
means for performing a subband full duplex (SBFD) operation in a case where at least one of following conditions is met:
a condition that total bandwidth of uplink subband within a Listen-Before-Talk (LBT) bandwidth occupies less than a first proportion of the LBT bandwidth and uplink transmission within at least one time resource for the SBFD is accompanied with a downlink transmission from the access network node which occupies at least a second proportion of the LBT bandwidth,
a condition that no other communicating node is detected as being present in a vicinity of the access network node and/or a user equipment (UE);
a condition that a distance between the UE and the access network node is less than a threshold;
a condition that a beam used by the access network node and/or the UE has a beam width in at least one dimension that is greater than a threshold, or is an omnidirectional beam; or
a condition that a semi-static channel occupancy mode, or frame-based equipment (FBE) mode, is used.

Some or all of elements specified in any of Supplementary Notes may be applied to various types of hardware, software, and recording means for recording software, systems, and methods.

This application is based upon and claims the benefit of priority from Great Britain patent application No. 2309384.2, filed on Jun. 21, 2023, the disclosure of which is incorporated herein in its entirety by reference.

### REFERENCE SIGNS LIST

1 Communication System
3 UE
3-1 UE
3-2 UE
3-3 UE
5 RAN node
5 base station
7 Core Network
9 Cell
10 control plane functions
10-1 AMF
10-2 SMF
10-n Other Functions
11 UPF
20 External Data Network
31 Transceiver Circuit
33 Antenna(s)
35 User Interface
37 Controller
39 Memory
41 Operating System
43 Communications Control Module
51 Transceiver Circuit
53 Antenna
55 Core Network Interface(s)
57 Controller
59 Memory
61 Operating System
163 Communications Control Module

What is claimed is:

1. A method performed by a mobile device, the method comprising:
receiving, from an access network node, configuration information for configuring frequency resources in at least one time resource for subband full duplex (SBFD) to meet an occupied bandwidth requirement of a Listen-Before-Talk (LBT) bandwidth, and
configuring the frequency resources based on the configuration information.

2. The method according to claim 1, wherein
each of at least one downlink subband of the frequency resources and at least one uplink subband of the frequency resources is distributed throughout the LBT bandwidth.

3. The method according to claim 2, wherein
frequency resources for the at least one downlink subband and frequency resources for the at least one uplink subband are interlacedly allocated.

4. The method according to claim 3, further comprising:
determining an unused set of frequency resources to remain unused for uplink or downlink communication in the LBT bandwidth.

5. The method according to claim 4, further comprising:
receiving, from the access network node, further configuration information for configuring the unused set of the frequency resources, and
wherein the determining is performed by determining based on the further configuration information.

6. The method according to claim 4, wherein
the determining is performed by determining based on the frequency resources for the at least one downlink subband and the frequency resources for the at least one uplink subband.

7. The method according to claim 3, further comprising:
receiving downlink transmission that is rate matched around frequency resources that do not belong to the frequency resources for the at least one downlink subband.

8. The method according to claim 3, further comprising:
receiving downlink transmission that is rate matched around the frequency resources for the at least one uplink subband.

9. The method according to claim 3, wherein
the configuration information includes information for indicating at least one downlink interlace within the frequency resources for the at least one downlink subband, and the method comprising:
receiving downlink transmission using the at least one downlink interlace.

10. The method according to claim 3, wherein
the configuration information includes information for indicating at least one uplink interlace within the frequency resources for the at least one uplink subband, and the method comprising:
transmitting uplink transmission using the at least one uplink interlace.

11. The method according to claim 3, further comprising:
transmitting uplink transmission without performing LBT while downlink transmission is continuously performed at the time when the uplink transmission is expected to start, wherein
the transmitting the uplink transmission without performing the LBT is restricted to at least one of:
a specific number of uplink transmissions within a channel occupancy time acquired by the access network node,
uplink transmission whose uplink transmission period is less than a specific threshold,
the mobile device associated with a beam that is used by the access network node to perform the LBT and/or to perform downlink transmission, or
a case where the LBT is of a type-1 channel access procedure with a priority associated with a longest contention window period.

12. The method according to claim 3, further comprising:
determining a period during which downlink transmissions are temporarily stopped;
temporarily stopping the downlink transmissions before performing LBT; and
performing the LBT in the period during which the downlink transmissions is temporarily stopped.

13. The method according to claim 12, wherein
the period is configured to occur in at least one specific time resource.

14. The method according to claim 13, wherein
the at least one specific time resource includes a symbol at a start of a slot and/or a 7th symbol of a slot or subframe.

15. The method according to claim 12, wherein
the period is configured to occur at least one of:
between two downlink transmissions, or
during an ongoing downlink transmission, and the method further comprising:
rate matching the downlink transmissions based on the period.

16. (canceled)

17. The method according to claim 1, wherein
the LBT bandwidth includes either a downlink subband of the frequency resources or an uplink subband of the frequency resources.

18-25. (canceled)

26. The method according to claim 1, wherein
total bandwidth of uplink subband within the LBT bandwidth occupies less than a first proportion of the LBT bandwidth and uplink transmission within the at least one time resource for the SBFD is accompanied with a downlink transmission from the access network node which occupies at least a second proportion of the LBT bandwidth.

27-29. (canceled)

30. A method performed by an access network node, the method comprising:
transmitting, to a mobile device, configuration information for configuring frequency resources in at least one time resource for subband full duplex (SBFD) to meet an occupied bandwidth requirement of a Listen-Before-Talk (LBT) bandwidth, wherein
the configuration information causes the mobile device to configure the frequency resources.

31. (canceled)

32. A mobile device comprising:
at least one memory configured to store instructions; and
at least one processor configured to execute the instructions to:
receive, from an access network node, configuration information for configuring frequency resources in at least one time resource for subband full duplex (SBFD) to meet an occupied bandwidth requirement of a Listen-Before-Talk (LBT) bandwidth, and
configure the frequency resources based on the configuration information.

33-35. (canceled)
